(19) United States
(12) Patent Application Publication
(10) Pub. No.: US 2010/0046792 A1
(43) Pub. Date: Feb. 25, 2010

(54) METHODS FOR COUNTING CORN SILKS OR OTHER PLURAL ELONGATED STRANDS AND USE OF THE COUNT FOR CHARACTERIZING THE STRANDS OR THEIR ORIGIN

(75) Inventors: STEVEN R. ANDERSON, DES MOINES, IA (US); RONALD L. FARRINGTON, NEVADA, IA (US); DANIEL M. GOLDMAN, DES MOINES, IA (US); TRAVIS A. HANSELMAN, JOHNSTON, IA (US); NEIL J. HAUSMANN, DAVIS, CA (US); JEFFREY R. SCHUSSLER, MARION, IA (US)

Correspondence Address: MCKEE, VOORHEES & SEASE, P.L.C.;ATTN: PIONEER HI-BRED, 801 GRAND AVENUE, SUITE 3200, DES MOINES, IA, 50309-2721, US

(73) Assignee: PIONEER HI-BRED INTERNATIONAL, INC., JOHNSTON, IA (US)

(21) Appl. No.: 12/545,266

(22) Filed: Aug. 21, 2009

Related U.S. Application Data
(60) Provisional application No. 61/091,054, filed on Aug. 22, 2008.

(51) Int. Cl. G06K 9/00

(52) U.S. Cl. 382/100

(57) ABSTRACT

Methods for relatively high throughput counting of elongated strands including silks of a plant. One method includes segregating similar sized pieces of silks from a section of the plant's silk brush and quantitatively counting the pieces using an automated method. The automated method can be a digital image of the pieces distributed across or above a surface, and image analysis to derive a count of individual pieces. An alternative automated method is to move the pieces sequentially and substantially singulated past a detector.

### RELATED APPLICATIONS

This application claims priority under 35 U.S.C. §119 to provisional application Ser. No. 61/091,054 filed Aug. 22, 2008, which application is hereby incorporated by reference in its entirety.

### I. BACKGROUND OF THE INVENTION

A. Field of the Invention

The present invention relates to counting of relatively small, discrete elongated strands or items automatically or semi-automatically with relatively high throughput and acceptable accuracy and, in particular, using the counting in a variety of applications. One specific application of the invention is counting relatively small, elongated parts of a plant (e.g. silks of a maize ear), and using the count for beneficial purposes such as, for example, characterizing a plant or its genotype, or determining if a plant or its genotype has desirable traits or characteristics for further research or commercial purposes.

B. Problems in the Art

Advancements in performance of plants are highly desirable. End users want varieties and hybrids that perform well for given conditions. Seed companies therefore expend substantial resources to develop varieties and hybrids to meet those demands.

However, research and development related to plants is complex, labor intensive and time-consuming. This places substantial demand on plant scientists to improve research methodologies.

One example relates to corn. It has been discovered that the number of silks that emerge from an ear of the corn plant can be a good indicator of, inter alia, potential seed yield from that plant. Thus, scientists can manually count silks on an inbred or hybrid genetic line and predict potential yield or yield components for that variety or hybrid. This can assist in making decisions about whether the particular inbred or hybrid variety is a good candidate for continued development or commercialization. As is well-known in the art, experimental evaluations often involve simultaneous observation of hundreds or thousands of different varieties or hybrids for desirable traits.

However, a conventional method of counting silks involves manually counting each silk section. The nature of corn silks, which emerge over a period of time in what is sometimes collectively called a brush, makes hand-counting highly time consuming and tedious (there are usually on the order of several hundreds of silks per ear, each silk having a small diameter and growing to several inches in length). Each of the relatively small silk strands must be positively identified and counted only once. This is somewhat like counting individual human hairs in a braid or tuft of hair. Not only does it take significant time, it is subject to error, especially if a worker has to count silks for multiple ears over an extended period.

It can be beneficial to obtain a silk count without having to remove the ear such that the ear can be pollinated with no material difference from a plant that has not been sampled. If counting is done outdoors on a living plant, it is more cumbersome due to adverse environmental conditions (e.g. wind, heat, dirt).

It can also be beneficial to obtain the count quickly, so that decisions about the inbred or hybrid line can be made as early as possible. The conventional manual method of silk counting can require significant labor and time, which can delay the ability to use the silk count information effectively. As can be appreciated, the labor costs and delay is magnified by the number of plants to be counted, which in some commercial seed experiments can be tens of thousands. Also, silks emerge at different times and rates, making comprehensive counting difficult especially if the count is taken early in the silk emergence time window.

Therefore, there is a real need in the art to provide a corn silk counting methods which can present potential improvement in:

a. throughput (average time per count);

b. time;

c. accuracy;

d. repeatability and reproducibility;

e. convenience;

f. portability; and

g. flexibility.

There is a need for the ability to at least partially automate the counting and to handle data about the counting and the plant or ear to which the count relates. This could be advantageously used, for example, in assessing production output as affected by environment, genotype, or agronomic management practices. It could also be beneficial for maximizing pollination and minimizing adventitious presence. The effects of pollination and kernel abortion on yield are discussed at Anderson et al., 2004 Crop Sci. 44:464-473, incorporated by reference herein.

Thus, there is a need for a faster, higher throughput, more efficient, and more accurate method for silk counting. There is a need for a quantitative, accurate, quick, reliable, and reproducible way of extracting silk samples from corn and other plants. There is also a need for a quantitative, accurate, quick, high reliability and reproducible way of counting silk from corn and other plants. Likewise, there is a need for an improved method to characterize silk emergence, growth, and other characteristics for a plant, compare such characteristics between plants or varieties of plants, evaluate environmental or cultural practices, and/or evaluate plants or varieties of plants relative to their traits or characteristics and for further use, or not, in commercial production, plant breeding or research and development, for example.

Other types of counting relatively small elongated parts or items of corn plants, or other plants, have analogous issues, which may be addressed in analogous ways by one or more aspects of the present invention. Also, similar benefits could be achieved in acquiring a quantitative sample of the parts or items to be counted and counting a plurality of elongated non-plant strands or pieces. A few non-limiting examples include fiber optics, hair, thread, fibers, filaments, skein, wires, tendons, strings, and the like. The count could be used, for example, in quality control checks to make sure a consistent number of strands is included in each of a plurality of bundles of strands. Another example would be to check for variability between sets or bundles of strands.

### II. SUMMARY OF THE INVENTION

One aspect of the present invention relates to methods to automatically or semi-automatically count silks of an ear of maize to reduce labor and time overhead of manual counting. The methods can be applied to analogous counting of silk on other types of plants, or counting of other plant parts or related items, or to counting of non-plant items.

Another aspect of the present invention is to increase speed of obtaining data about silk count from an ear of maize. The data can be advantageously used for a variety of purposes, including but not limited to, (a) making earlier and better selections of plants exhibiting desirable phenotype or genotype, (b) understanding the biological processes of the plant for research and development purposes, or (c) planning and business management related to producing seed from the plants.

Another aspect of the invention relates to obtaining a quantitative sample of a plurality of elongated strands or pieces in a form that can be counted using an image evaluation method. In the case of silk of maize, a further aspect of the invention includes the ability to obtain the sample without adversely affecting the ear.

A further aspect of the invention includes a high throughput method for quantifying relatively small, elongated pieces. A quantitative sample of cuttings of the pieces is obtained and suspended in a liquid. The sample is placed in isolation and the cuttings that comprise the sample are encouraged to distribute evenly generally in a plane. An image taken essentially orthogonal to the plane, and focused at or near the plane, is analyzed with image measurement or analysis software pre-programmed to recognize and count each object in the image which is indicative of a cutting from the sample. The image of each of multiple samples can be taken efficiently and sequentially, and stored. Image analysis can also occur efficiently. This can result in relatively high throughput of multiple samples compared to prior methods.

A further aspect of the invention comprises accurate and reliable quantification of the number of pieces based on quantification of the sample cuttings of the pieces, and then use of the quantification. The use could simply be a statistically valid or acceptable count, or could be used in characterizing the sample, the pieces from which the sample was taken, or some other parameter related to the pieces or sample. For example, with respect to maize silk, the silk count quantification could be used for, inter alia, selection purposes in plant breeding, genetic advancement, crop production, evaluation of the effects of transgenic manipulation or to identify molecular markers associated with silk production or ear growth. Another aspect using silk quantification is to assess the impact of cultural and environmental factors on silk production. It can also be used to identify plants or varieties of plants with desirable traits or characteristics for commercial or research purposes. For example, the invention allows researchers to quickly extract silk from individual plants of maize and quantitatively determine the number of silks per ear. This information can be used to determine the yield potential of parent lines, which can be used for decisions about use of a parent line in commercial seed production. The information can be used as phenotypic information to search for molecular markers for silk production.

The methodologies can be used for other plants that produce multiple thin and elongated tissues.

The methodologies may be adapted for relatively high throughput and at least semi-automated quantification of count of other multiple strands or elongated pieces for various uses.

### III. BRIEF DESCRIPTION OF DRAWINGS AND APPENDICES

The following drawings are appended to, and referred to from time to time, in this description. They are intended to supplement this description and are incorporated by reference hereto.

### A. Drawings

### 1. Cutting Tool

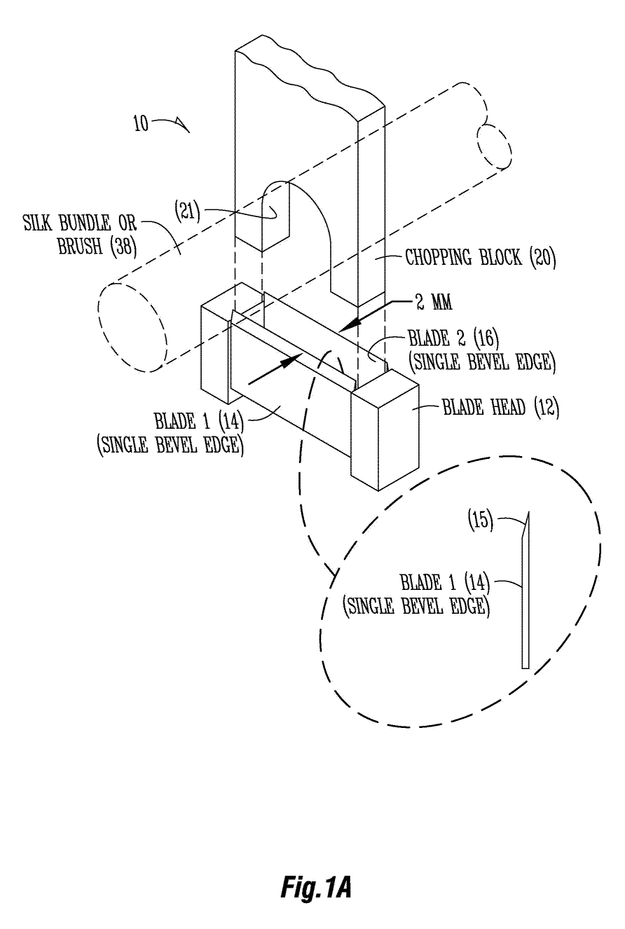

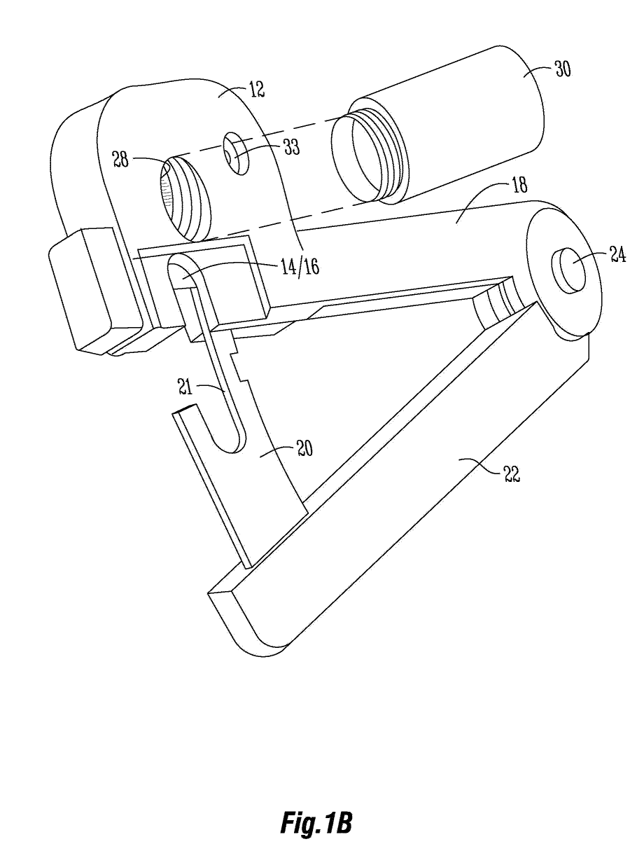

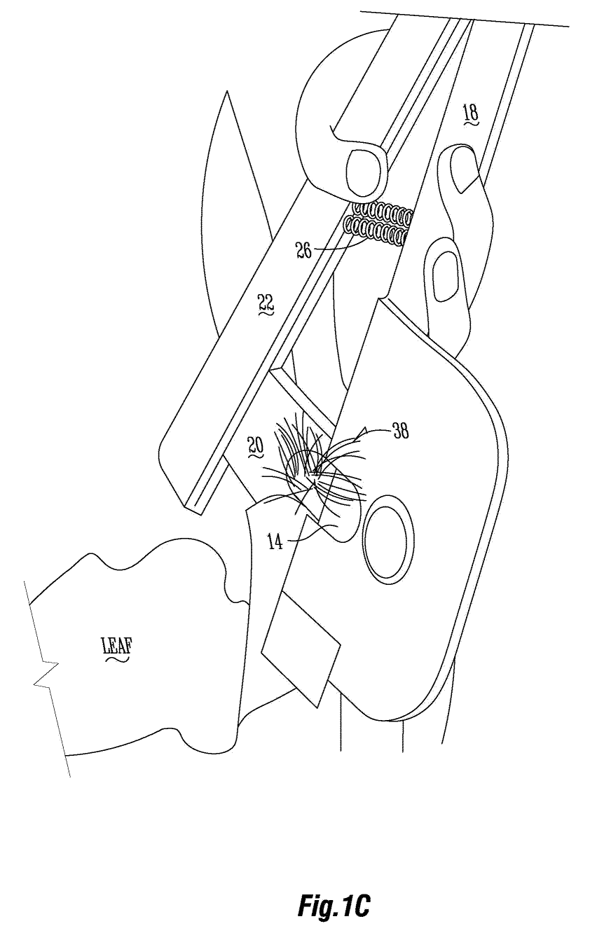

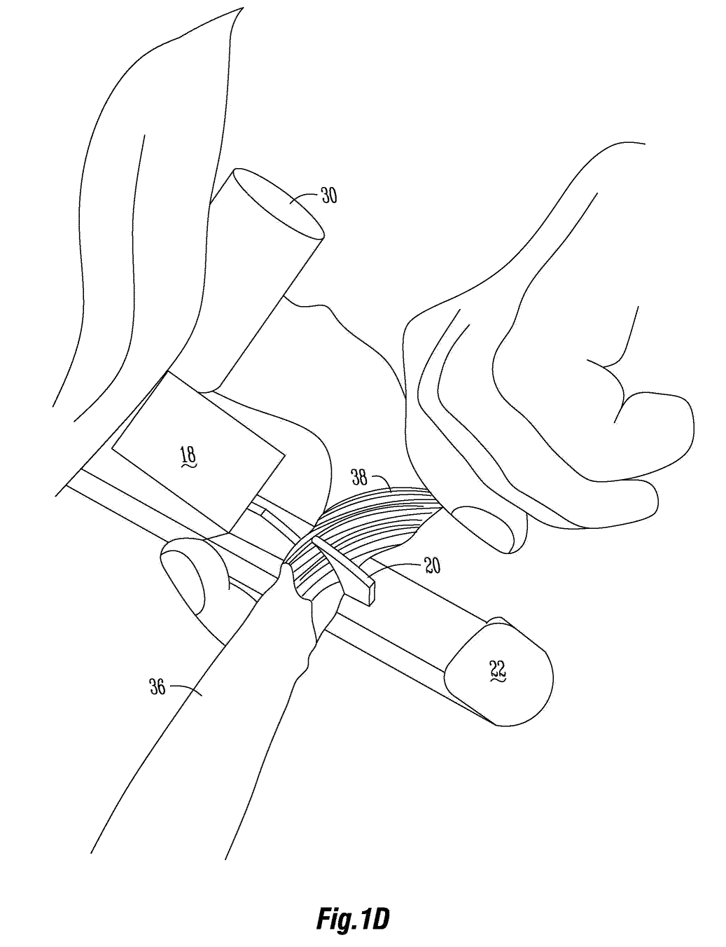

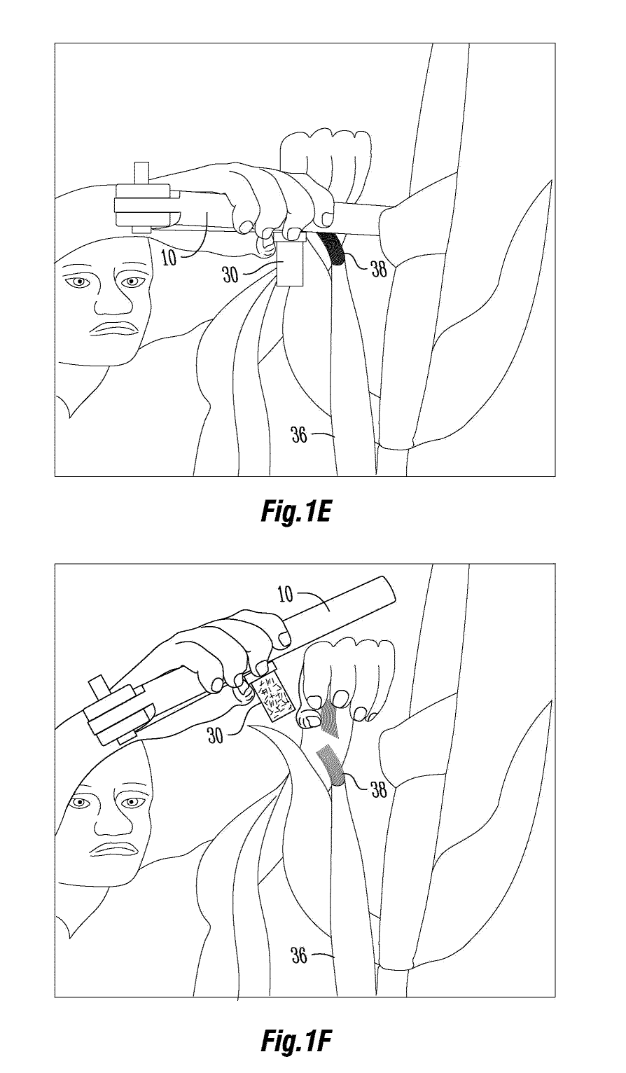

FIG. 1A is a simplified sketch of a portion of an exemplary embodiment of a cutting tool adapted to cut a silk brush of a corn plant to obtain substantially equal samples from each silk. It could also be used for obtaining a set of sample cuttings from other elongated strands or pieces, both plant and non-plant.

FIG. 1B is a perspective view of the entire cutting tool of FIG. 1A shown in an opened position.

FIG. 1C is a perspective view of the tool of FIG. 1B moved into a preliminary position relative the silk brush of a growing corn plant.

FIG. 1D is a perspective view of the tool of FIG. 1B moved down the silk brush to just above the husk in preparation for taking a sample.

FIGS. 1E and 1F are perspective views before and after taking of the sample and showing the remaining silk brush on the plant.

### 2. Embodiment One—Counting by Imaging Silk Cuttings

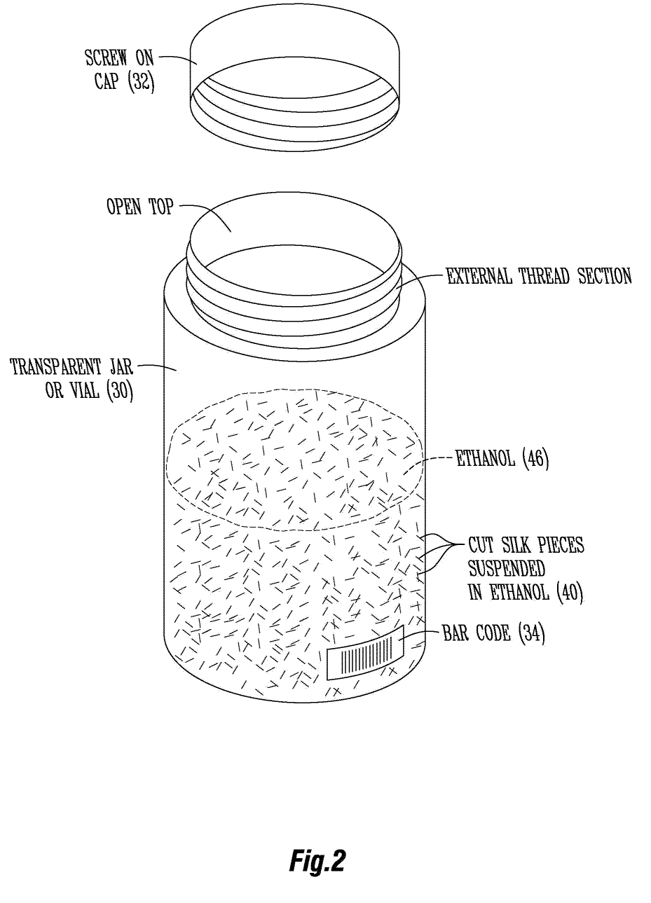

FIG. 2 is a sketch of a container into which the sample taken in FIG. 1E can be placed.

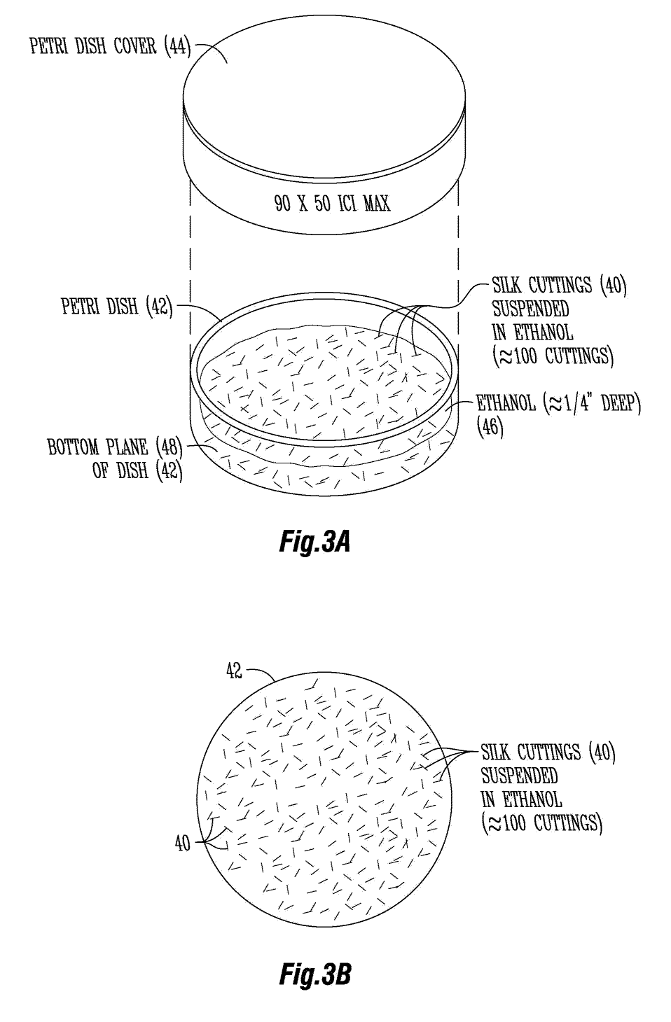

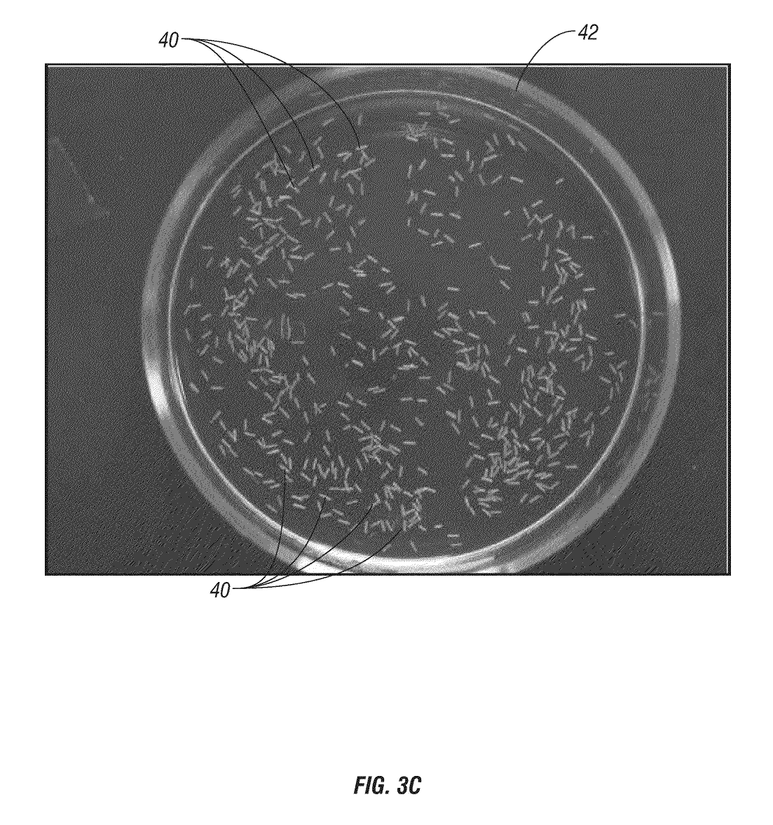

FIG. 3A is a sketch of a Petri dish into which the sample of FIG. 2 can be placed for imaging of the sample according to a first exemplary embodiment of the present invention.

FIG. 3B is a simplified top plan view of FIG. 3A illustrating how the pieces of the sample can be distributed for imaging.

FIG. 3C is a picture of an actual Petri dish and sample from the perspective of FIG. 3B.

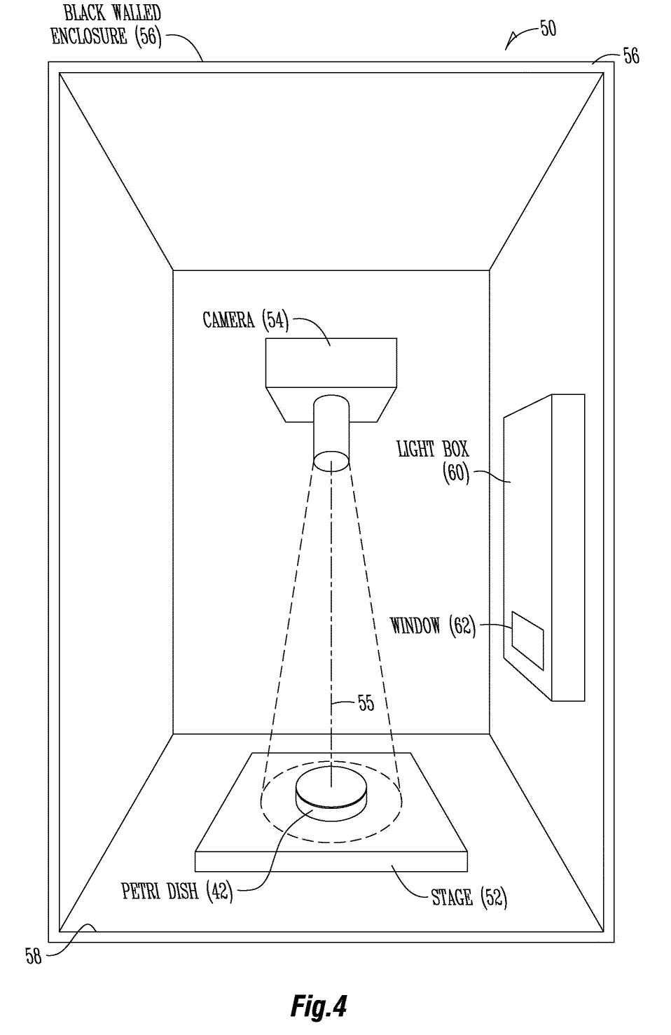

FIG. 4 is a simplified sketch of an imaging station for obtaining an image of the type shown in FIG. 3C.

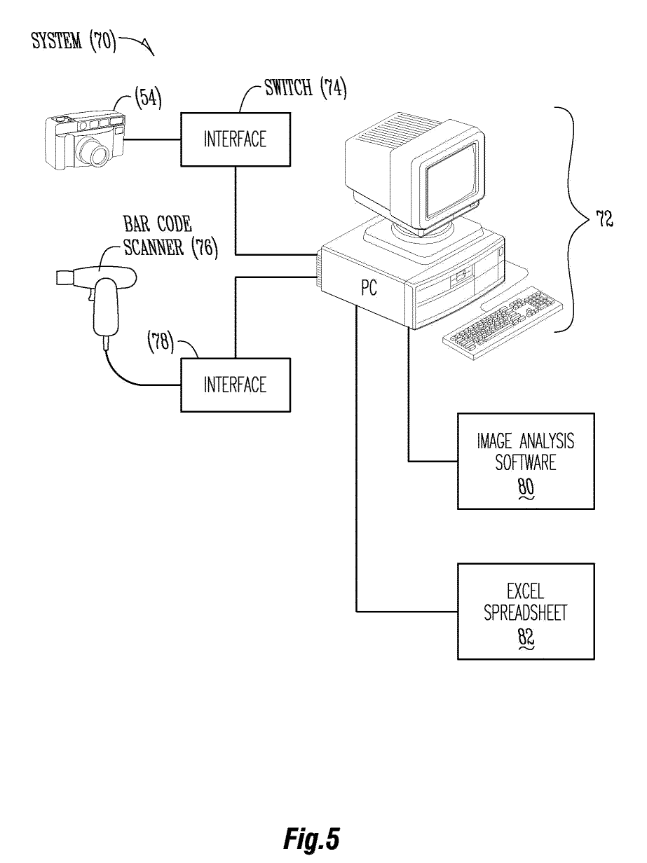

FIG. 5 is a diagram of a method for obtaining the image of FIG. 3C.

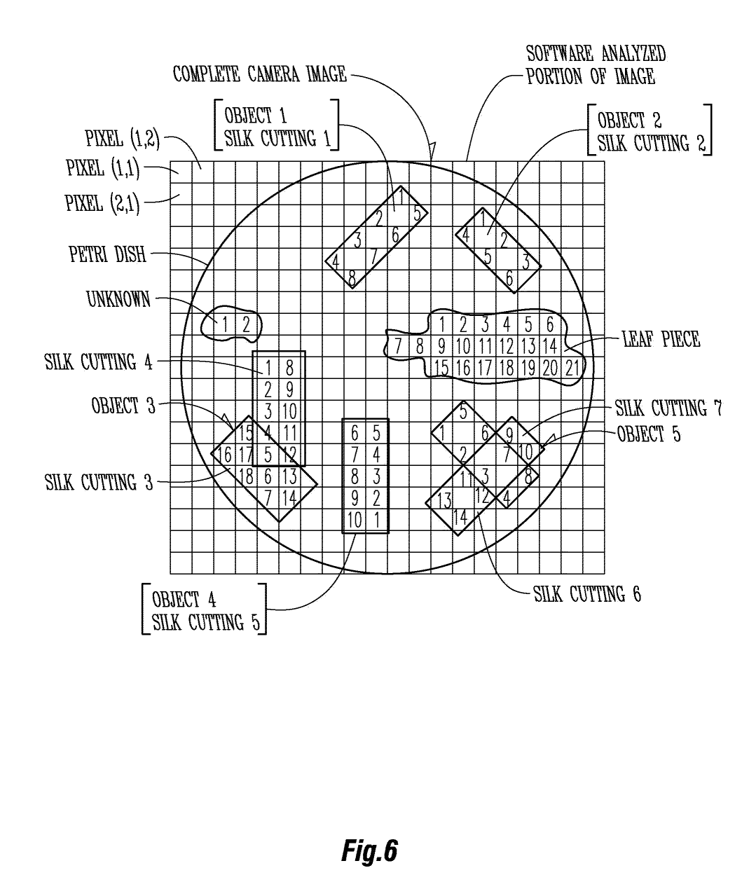

FIG. 6 is a simplified diagrammatic illustration of the type of image of FIG. 3C showing a method of automatically counting pieces of the sample from the image.

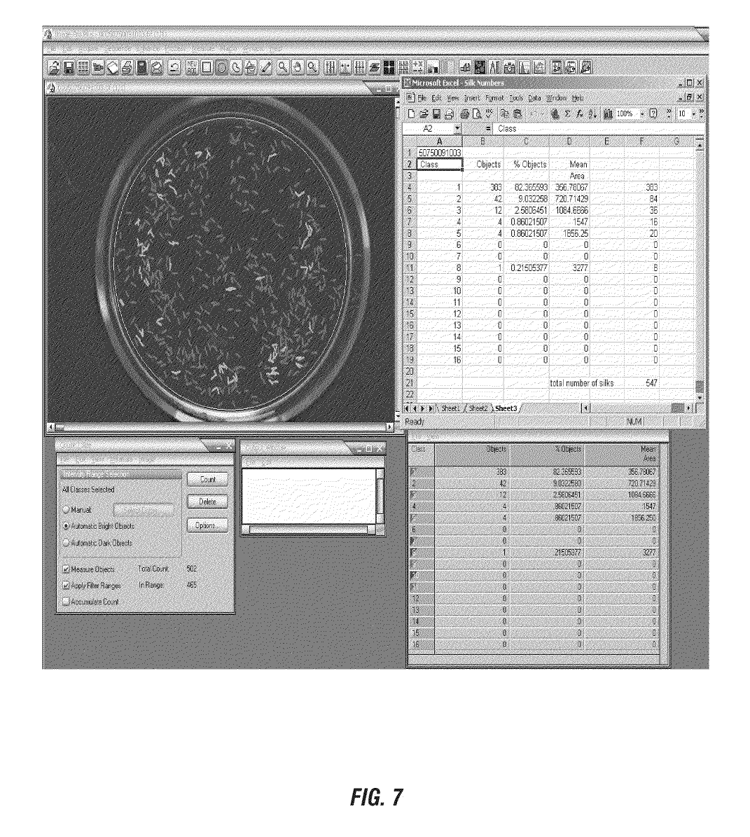

FIG. 7 is a computer screen display illustrating the sample image and the result of automatic counting of pieces of the sample.

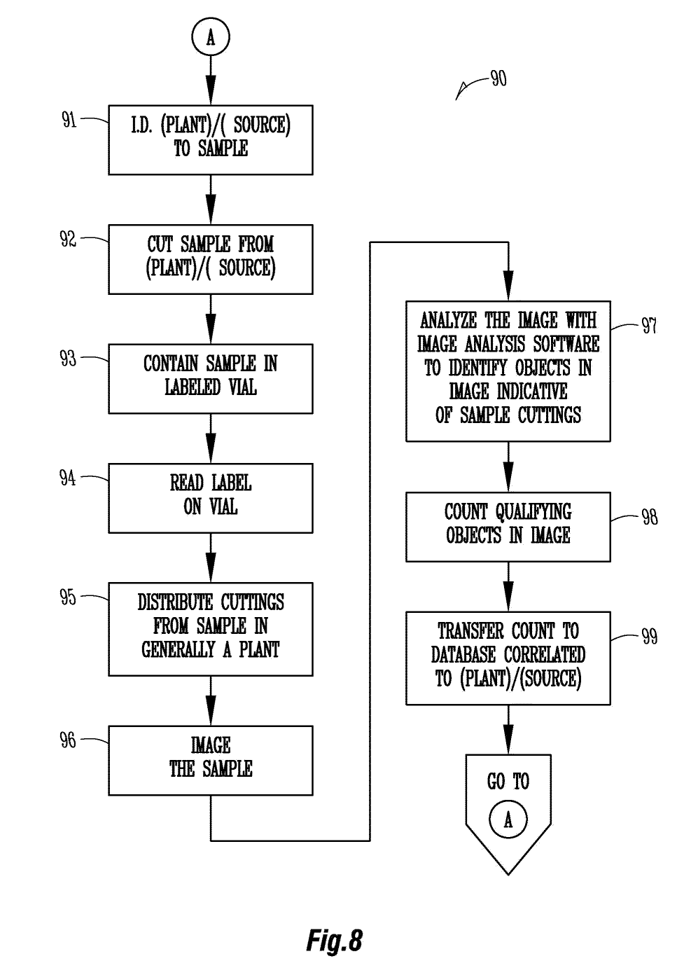

FIG. 8 is a flow chart of the method of counting illustrated by the preceding Figures.

### 3. Embodiment Two—Counting Silk Cuttings as Flow By a Detector

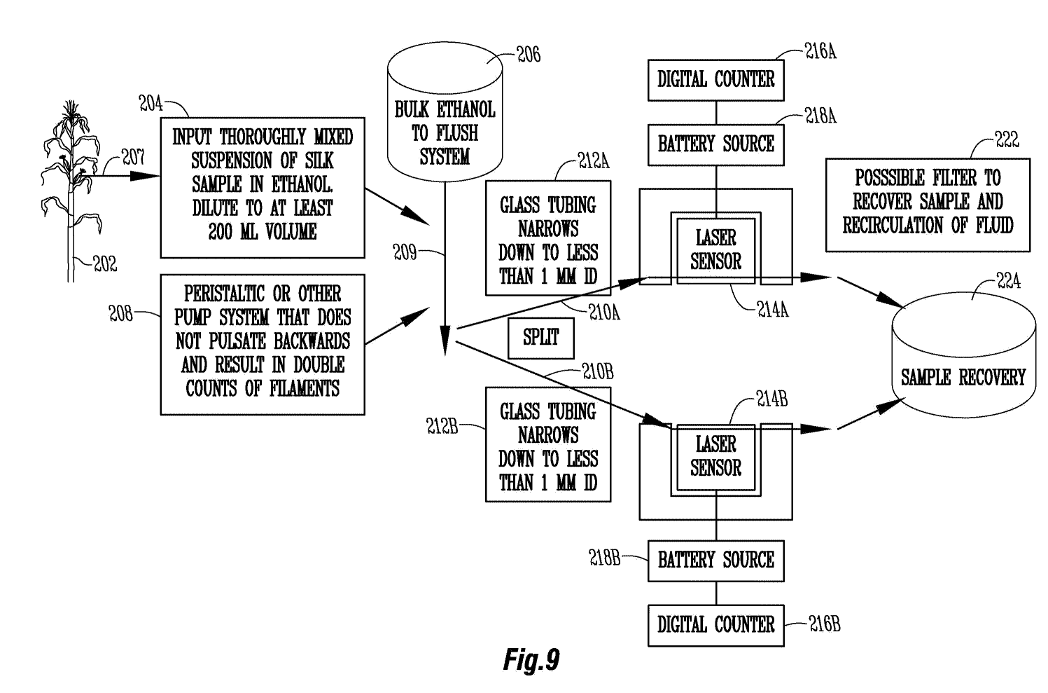

FIG. 9 is a diagrammatic illustration of a silk sample automatic counting method according to a second alternative exemplary embodiment of the present invention.

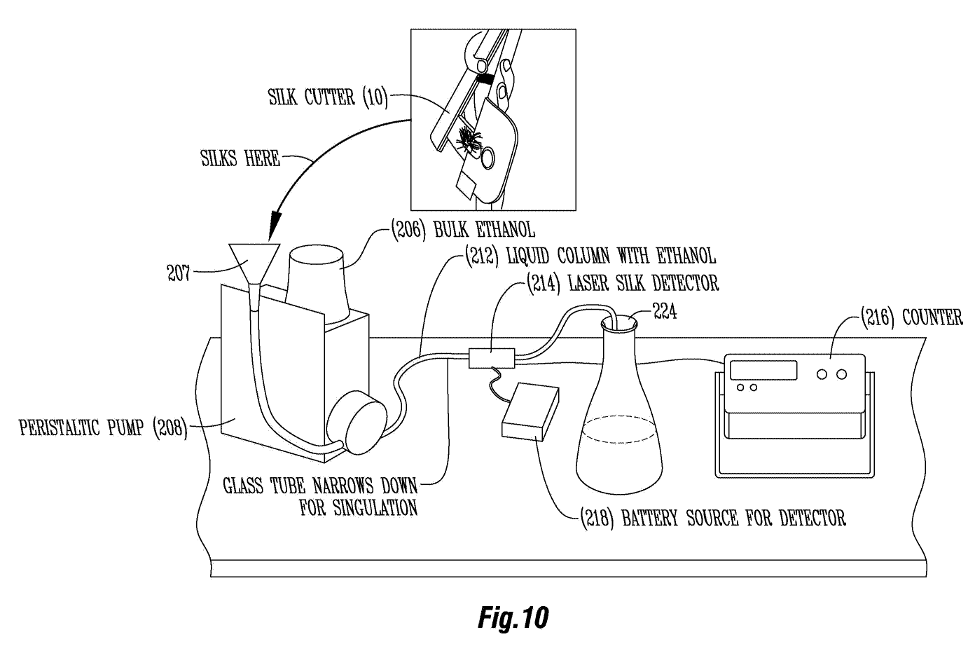

FIG. 10 is a picture of a prototypical method according to FIG. 9.

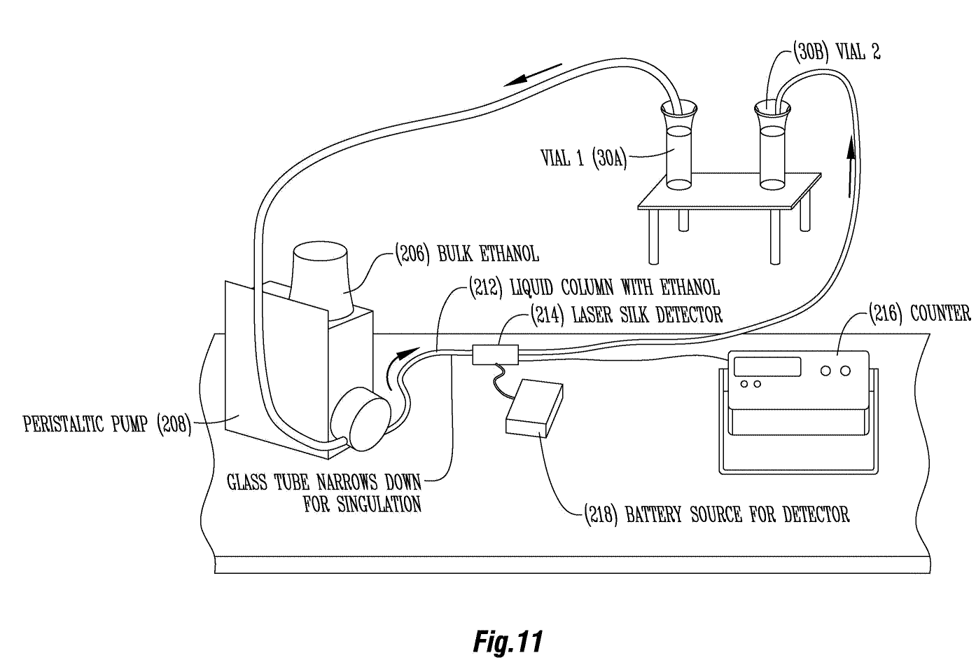

FIG. 11 is a picture of an alternative method according to the second exemplary embodiment.

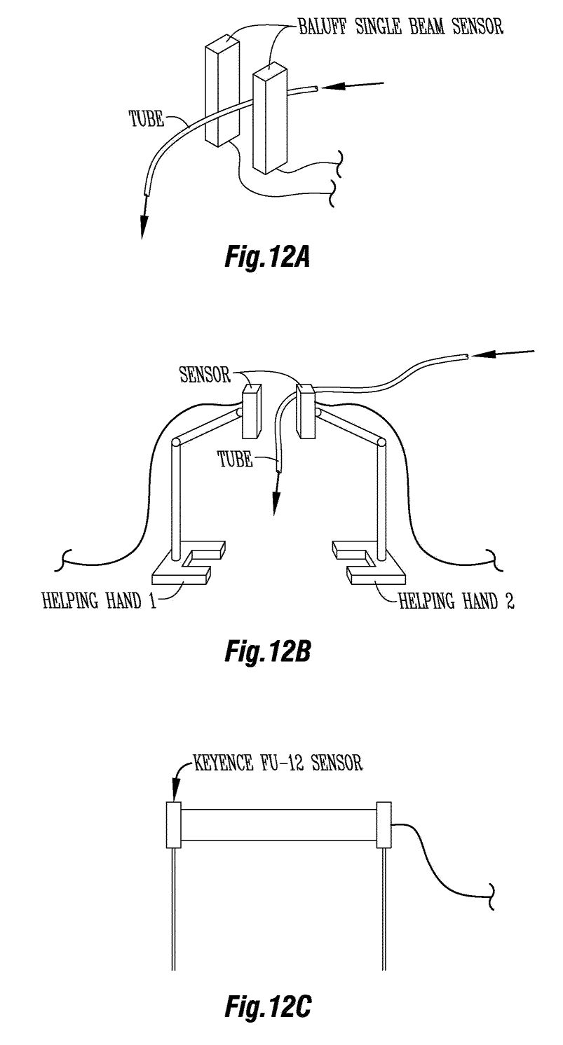

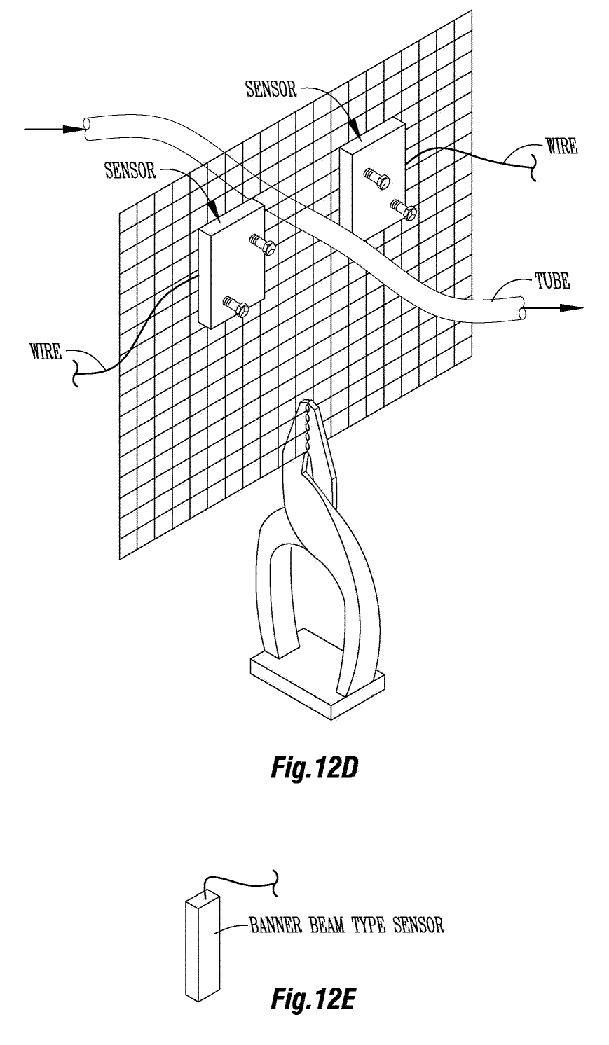

FIGS. 12A-E are isolated views of components from FIG. 10 or 11.

### 4. Embodiment Three—Counting Cross Section of Bundled Silks

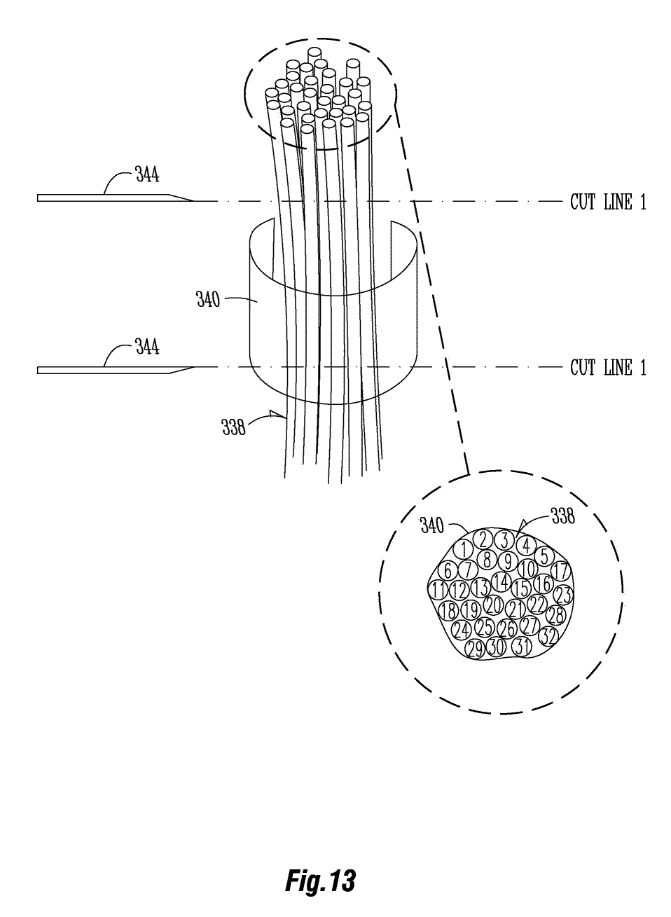

FIG. 13 is an enlarged illustration of a part of a third and alternative exemplary embodiment according to the present invention, where a cross-section of the cut corn silk brush is obtained and each silk is counted manually or on an image of the cross-section.

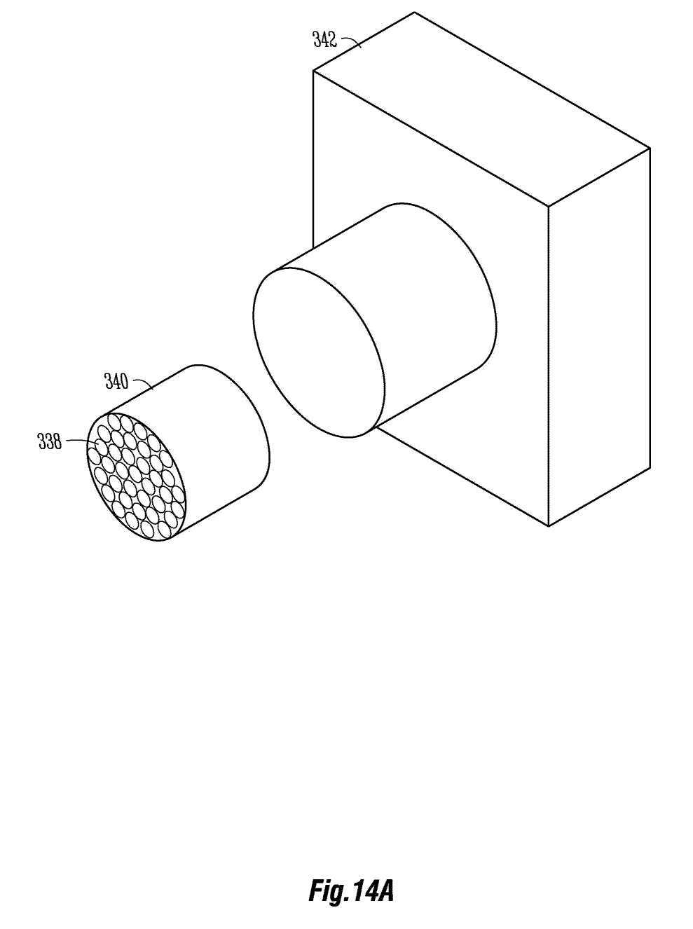

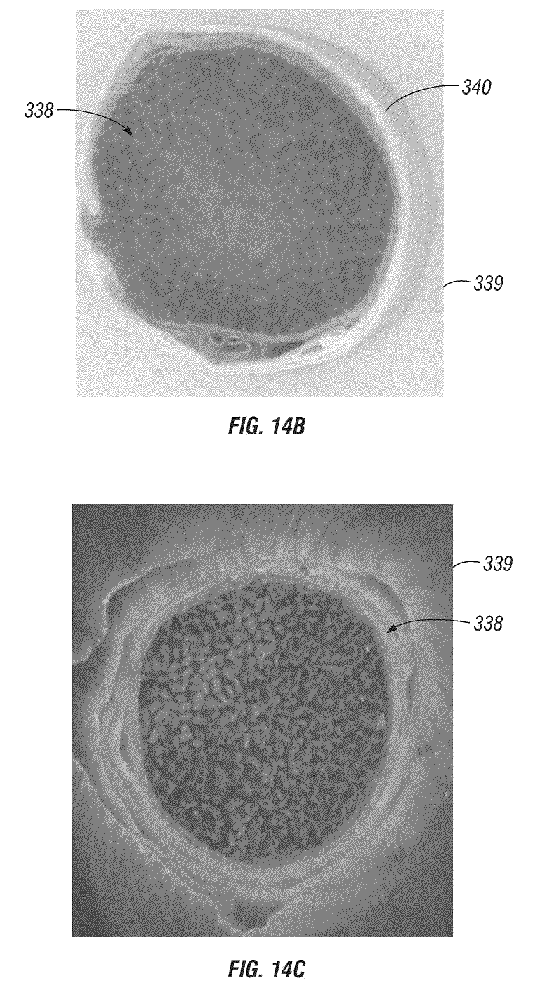

FIG. 14A shows a method of creating a bound silk sample in preparation for cutting.

FIG. 14B is an end plan view of one end of the bound silk brush sample of FIG. 14A.

FIG. 14C illustrates an optional step for the method of FIG. 13, that is, staining the exposed cross-section to attempt to achieve better contrast of individual silk from the bundle.

### 5. Examples of Uses and Correlations of Silk Counts

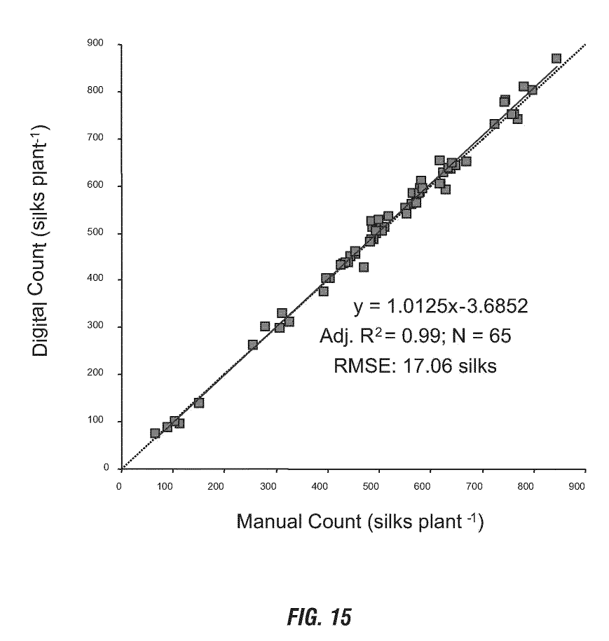

FIG. 15 is a graph illustrating accuracy of silk counts with imaging analysis of Exemplary Embodiment One.

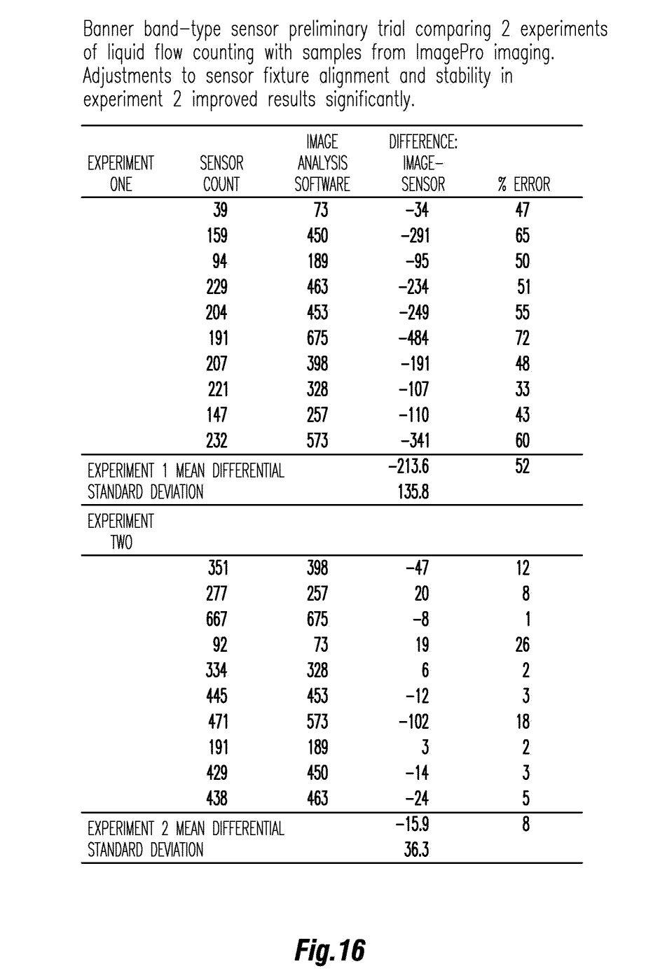

FIG. 16 is a table illustrating accuracy of silk counts with fluid flow and photo detector silk counting of Exemplary Embodiment Two.

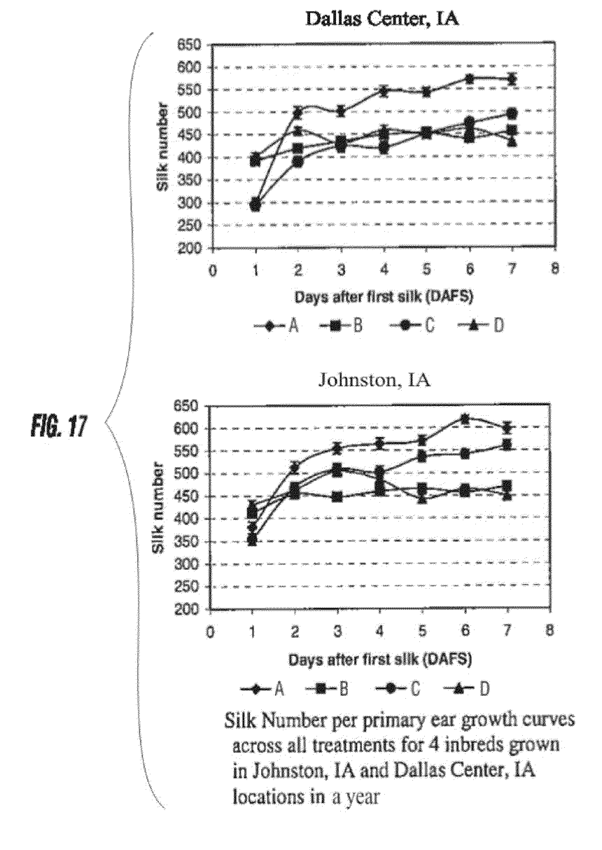

FIG. 17 are graphs illustrating silk number variability between genotypes, and showing silk growth curves over time.

### IV. DETAILED DESCRIPTION OF EXEMPLARY EMBODIMENTS

### A. Overview

For a better understanding of the invention, exemplary embodiments will now be described in detail. It is to be understood that these are not the only ways the invention can be embodied, but are for example and illustration of principles and aspects of the invention, which is not limited by these specific examples.

### B. Context

For simplicity, the exemplary embodiments will be discussed primarily in the context of counting silk of maize. It is to be appreciated that the embodiments and the invention can be applied to counting other items, including but not limited to other relatively small, elongated multiple strands or pieces of plants, or other relatively small, elongated strands or items whether or not related to plants.

### C. General Exemplary Method

FIG. 8 outlines a method (referred to generally as method 90) of extracting a sample from a “source”. In the context of the general method, the “source” is intended to mean an original or starting collection or bundle of a plurality of pieces or items. These pieces or items can be relatively small in diameter elongated strands. One example are silks of a plant. Another plant example is the fibers or strands of celery. Non-limiting non-plant examples are fiber optics, hair, thread, fibers, filaments, skein, wires, tendons, strings, insects or insect parts, eggs, pollen grains, pollen tubes, and the like. Method 90 of FIG. 8 also outlines a method of quantifying that starting collection or bundle.

1. Sample Collection

A starting plurality of unquantified pieces are identified (FIG. 8, step 91), e.g., to give the starting bundle a unique identifier to keep track of that starting bundle and correlate a count of its individual pieces to that unique identification. The worker has a priori knowledge of the identity of the bundle, and maintains a correlation of that identity with a sample that is collected from the starting bundle. The unique identifier can be written down, present on an associated tag or sticker, recorded on a hand-held computer or other device, or otherwise assigned.

One collection method cuts or otherwise separates or removes a section of the starting bundle (FIG. 8, step 92). This set of separated pieces of the starting bundle comprise a sample of the bundle.

The sample can be placed in a separate labeled container (FIG. 8, step 93) to segregate each sample from other samples and provide identification of the sample. The label can be or include a bar code or other indicia from which identity of the starting bundle can be derived, or upon which the unique identifier is placed. Information on the label can be machine-readable. If a container is not used, some other method of maintaining correlation of identity of the starting bundle and the sample can be used.

A variety of ways can be used to obtain the sample. Some are discussed in the more specific exemplary embodiments later. In some examples, a section taken from the whole bundle is intended to separate and preserve a substantially similar length section of each strand of the bundle. Ideally, the section from the bundle would include a cutting or section of each and every strand of the bundle. This would be a quantitative, if not exact, sample of the number of strands of the starting bundle.

Therefore, method 90 outlines a process that has been discovered to provide a relatively quick, statistically representative sample of discrete, similarly-sized sections of the strands making up the starting bundle.

2. Quantification

Method 90 also provides a process for obtaining a statistically acceptable quantification of the sample, once it is collected. It is to be noted that the quantification process can be applied to the collection process of steps 91-93, but also can be applied to a sample that has been collected by other methods, so long as the sample is quantitatively obtained. By quantitatively obtained it is meant that the sample is capable of measurement within a statistically acceptable margin of error of actual number of strands from the starting bundle. This margin of error can be selected for a given application. Ideally it would be exact. But for many purposes, a margin of error of +/−2% to 5% may be sufficient. Even larger margins of error may be acceptable in certain cases.

Quantification is obtained by distributing the cuttings or sections making up the sample generally in a plane (FIG. 8, step 95). The identifier of the sample can first be read, stored, and associated to the sample (step 94).

An image of the distributed sample is taken (step 96). In method 90, the distribution of the sample optionally can be in an isolation compartment or container. Either the whole area of the bottom of the container is imaged, or a predetermined sub-area. In either case, a relatively even distribution of the sample in the plane would allow a quantitative count of the individual cuttings or pieces.

In one example, the sample could optionally be suspended in a liquid to assist in even distribution across the plane. In many cases, the cuttings or pieces of the sample would tend to settle by gravity to the bottom of the container, thus settling in a plane. Furthermore, they would tend to settle with their longitudinal axes parallel to the plane, so that an image of the plane would likely capture the length dimension of each cutting. Normally, the liquid should not be destructive of the cuttings or change their size (at least not relative to one another). The liquid may also serve to preserve the sample for long term storage.

An image of the sample, or a known area related thereto, can be acquired using an imaging station (e.g. camera-based with digital imaging functions). Any of a number of commercially available imaging systems can be used. It can also be custom-made. Image analysis software compatible with the images can be used to identify (step 97) and count (step 98) what appear to be individual cuttings or pieces of the sample in the image, as opposed to debris or irrelevant items that might be mixed into the sample or appear in the image. By appropriate programming of the imaging analysis software, one or more dimensions or other criteria can be defined as indicating a cutting, and the imaging analysis software would identify objects in the image that meet the programmed dimension(s) or criteria. Validated identified objects could be counted by the software automatically. The count would be a quantification of total strands of the starting bundle of strands.

The count can be stored, e.g. in a database (step 99), in association with the identity of the sample, which can also be correlated back to the identity of the original starting bundle from which the sample came.

Therefore, method 90 presents a process by which a statistically acceptable quantification of strands or pieces from a starting bundle of plural strands or pieces can be derived. As can be appreciated by those skilled in the art, the quantification can be done quite quickly, even for large numbers of samples, in comparison at least to hand counting. As indicated in FIG. 8, steps 91-99 can be repeated for subsequent samples. Thus, quantification can be accomplished at a relatively high throughput with good statistical accuracy and then stored for further use on a sample-by-sample basis.

Moreover, the sample collection process can be managed to quickly and efficiently extract a number of samples successively and prepare them for imaging and counting. The imaging and/or counting can occur right after sample extraction or at later times, as is convenient or desirable. For example, it may be considered more efficient for a given application to obtain multiple samples over a first time period, store the samples in labeled vials, but then at a later time or times to image and analyze the images. Alternatively, it might be preferred for an application to obtain the samples and image them relatively soon thereafter, but delay image analysis for a later time. As an example, it might be deemed to be a more efficient use of time to image a number of samples, and then at a later time batch process the images. Method 90 therefore has good flexibility as to use and allocation of human and equipment resources. The method has also been found to be repeatable and reproducible, and therefore has high reliability.

A liquid handling system, such as are well known in laboratory settings, could be added to automate the addition of liquid and to extract a sample from a vial or container and move the sample suspended in a known volume of liquid to image analysis. Such liquid handling systems are commercially available and can be programmed to conduct needed functions. This can increase efficiency of the method.

Method 90 can be used to determine the number of strands or pieces in a starting bundle or a sectioned sample of the starting bundle. Information gained can be used for other purposes.

3. Sample Organization and Storage

As can be appreciated by those skilled in the art, there are a number of ways in which a number of the samples obtained in method 90 can be handled and organized in an efficient and orderly fashion. One way widely used in laboratory settings is use of mini-vials, Scintillation vials, or other containers for containing and segregating individual samples. Another is the use of a multi-well tray as a convenient way to isolate, store and maintain correlation of identity of multiple samples. A label (e.g. machine-readable label such as a bar code) could be placed on the tray or other container and include identifying information about the container and samples in the container. The volume of each container could be large enough to hold a complete sample suspended in liquid. Either an automated liquid handling system or a manually operated pipette, such as are known in the art, could be used to move liquid-suspended samples to and from imaging while maintaining correlation to identifying information for each sample.

4. Utilization of Count

As can be appreciated, a quantitative count obtained for a sample or each of a set of samples can be used in a number of ways. Some illustrative examples include the following.

There are situations where it would be advantageous to check if bundles of strands are manufactured or assembled to have the same number of strands. Fiber optics bundles may need to have the same number of strands so that each presents the same number of channels or capacity for light modulated communications over the bundle. Method 90 could be used to at least spot check random bundles to verify that each assembled bundle has the same number of strands, within a margin of error. The method could generate an alert or alarm if a count outside the margin of error is measured. The same process could be used to check consistent count for packaged threads, wire, and the like. The method could keep bundle counts within a margin of error for quality control.

On the other hand, there are situations were it would be advantageous to measure whether there is variability in the number of strands between bundles. As mentioned, an example would be maize silk. Method 90 could be used to identify genotypes of maize that exhibit desirable silk count indicative of higher yield.

Other examples of uses and applications of a count of silk are described later.

Thus, the general method described above addresses the identified needs in the art. Following are specific illustrative, non-limiting examples of forms in which aspects of the general method could be implemented.

### D. Specific Exemplary Embodiment One—Image Analysis

### 1. Summary

A first exemplary embodiment, called embodiment one, obtains a short segment or cutting of each silk of an ear of maize, distributes them substantially in a plane, images the plane, and utilizes image recognition software to identify parts of the image indicative of an individual silk segment and count all such segments automatically. The results are stored in a fashion which is correlated with an identification of the ear (or its variety or genotype) from which the silk segments came, thus allowing computerized data processing of the information for a variety of applications.

This embodiment allows small silk samples to be removed from a living corn plant, without materially affecting the plant's on-going viability. As silk continues to grow, the ear can be pollinated and mature in a regular fashion. The counting can be accomplished when desired (e.g. relatively quickly after sample collection or at a later time). Samples from a plurality of plants can be obtained and brought to a counting station for efficient processing. This has been found to reduce the time of silk counting significantly, and that the counting accuracy is within acceptable range.

Also, the embodiment allows a silk sample to be taken at a first time, and one or more subsequent samples taken and counted from the same plant (e.g., if silks grow sufficiently between sampling times). This can be used, for example, to track silk growth or emergence parameters from the same plant over time.

a) Cutting Tool

FIGS. 1A-E illustrate a cutting tool 10 that can be used to obtain the sample from plants. Two razor blades 14 and 16 (single bevel edge 15) are held at a fixed distance from each other in a parallel orientation in a blade head 12 of one arm 18 of tool 10 (top arm in FIG. 1B). A second arm 22 includes an extension with a semi-circular cut out 20. The cut-out 21 defines basically a curved concave blunt edge having a width that fits between the razor blades 14/16. The arms 14/16 are pivotally attached (reference number 24) at proximal ends (FIG. 1B). In the normally open position (FIG. 1B), the blunt edge 21 is away from the blades. The arms 18/22 can be held normally apart by a spring 26 (e.g. FIG. 1C) or other biasing means.

When the tool arms 18/22 are open, a tautly-drawn silk brush 38 can be positioned through cut-out 21 (FIGS. 1A, 1C and 1D) in preparation for sample-taking. The worker squeezes the tool arms 18/22 together and the double-blade 14/16 would cut through silk brush 38. The cut-out 21 acts somewhat as a chopping block. Its blunt edge 21 is a surface against which the silk bundle abuts while blades 14/16 cut through the silks.

As illustrated in FIG. 1A, blades 14/16 would cut fully through silk brush 38 because they can move to and pass by on opposite sides of cut out 21. Once the cutting stroke is complete, the worker releases arms 18/22 of tool 10 to return to the normal open position. This would leave the remaining portion of silk brush 38 intact on the plant to continue to grow (FIG. 1F). The blades can be removably mounted in head 12 of tool 10 by fasteners or clamping action. Use of sharp single beveled blade edges 15 at approximately 90 degrees angle to the silks is intended to produce a clean cut through the silks, as opposed to an angled cut or tearing or compressing the silks.

The short segments or cuttings 40 of silks cut from silk brush 38 by parallel, spaced-apart blades 14/16 would be caught by the worker or captured in tool 10. In this embodiment of tool 10, a vial 30 can be connected to the side of head 12 of tool 10 and tool 10 can be turned over and sprayed with liquid (e.g., ethanol) to rinse silks into vial 30 causing the segments or cuttings 40 captured inside head 12 to fall into vial 30 by gravity and/or manipulation of tool 10 (FIG. 1D). Vial 30 can have an externally threaded open end that mateably threads into and out of a complementary internally threaded aperture 28 in the side of head 12 of arm 18. Aperture 28 would be in communication with the space between blades 14 and 16. Basically the cuttings 40 can by pushed or otherwise moved to the back of blades 14 and 16 by moving cutout 21 towards the back of blades 14/16. The cuttings would move opposite the beveled cutting edges 15 into a chamber in head 12 and out of opening 28 into vial 30, when vial 30 is mounted on head 12 as tool 10 is turned with vial 30 pointing down. Other methods of attachment and other containers could be used.

As illustrated in FIGS. 1A-F, the sample cuttings 40 are similar length silk sections cut from the same place near the distal end of silk brush or bundle 38. This leaves a proximal part of silk brush 38 intact on maize ear 36, where it can continue to grow and can be pollinated. The sampling is therefore non-destructive to the ear and plant in the sense that it does not materially affect the viability or health of the plant, or the function of the silk in the plant processes.

A bar-coded or other label can be placed on the vial (e.g. 20 milliliter volume capacity) to relate the identity of its plant to the sample (cuttings 40).

It can therefore be appreciated that the tool can separate relatively uniform, short segments or cuttings 40 (e.g. approx. 1.5 mm to 2 mm in length—the width between blades 14 and 16) from one or more silk brush 38 of the plant without materially affecting continued viability of the plant. The sharp, single bevel razor blades 14/16 in this example are spaced approximately 2 mm apart and the tool scissors' action obtains clean-cut segments, sections, or cuttings 40. It avoids smashing or tearing of the silks. Thus, tool 10 promotes recovery of a substantially equal-size segment 40 for each silk of a silk brush 38 of a plant.

In this example, the sample is taken greater than 3 cm above the tip of the husks of ear 36 to leave a silk brush 38 which will be pollinated naturally. Silks emerge over time from each ear floret acropetally (base of ear to tip). It is important for estimating total silk number to allow sufficient temporal silk emergence.

Other methods and tools can be used to obtain a sample of cuttings 40 all of approximately the same length. Cutter 10 facilitates an example of a one-step, relatively accurate and quick method for obtaining relatively short but uniform cuttings.

b) Vial

As discussed, the sample segments 40 of silks from a plant can be collected in a vial 30 or other container (e.g. Liquid Scintillation Vial, High Density Polyethylene, with screw cap, from Wheaton Science Products of Millville, N.J. USA) which includes a machine-readable label 34 (e.g. 1″×1.25″ white thermal transfer label created with a 105S1 printer from Zebra Technologies of Vernon Hills, Ill. USA).

In this embodiment, vial 30 includes a removable cap 32 to seal vial 30 (FIG. 2). Furthermore, once sample segments 40 are in vial 30, in this example the vial 30 is at least partially filled with a fluid 46 (e.g. ethanol) to preserve the sample (for months if needed), and cap 32 is secured. Fluid 46 can be anhydrous, denatured (SDA Formula 3A) Reagent Grade Ethanol available from VWR International of West Chester, Pa. USA. Ethanol is used to preserve sample with little to no degradation. Other preserving fluids could be used.

This allows sample 40 to be basically packaged and secured for transport to a counting station, even if such a station is remote from the plant. The worker can proceed to obtain the next sample 40, and package it into its own vial 30, and so on.

Other containers or methods to isolate and/or store a sample, with or without a liquid, are possible.

c) Petri Dish

At a counting or imaging station 50, described later, the contents of vial 30 can be emptied into a Petri dish 42 (FIG. 3A). Care should be taken to evacuate all silk cuttings 40 from vial 30. The size of Petri dish 42 is selected so that the ethanol 46 assumes no more than a relatively thin layer (e.g. approx. ¼″ and 25 ml) in dish 42 (e.g. Crystallizing Dish (100 mm×50 mm) from VWR International). A greater volume of fluid 46 might be used to attempt to obtain more spreading of cuttings 40, but usually a minimum amount of fluid 46 is used to attempt to spread cuttings 40 in roughly a plane. It is difficult or impossible to avoid overlapping or touching silks. Specialized computer scripts have been written for image analysis software 80 of image analysis system 70, discussed below, to estimate the number of silks in overlapping or touching groups. Dish 42 can be shaken to promote as even a distribution of the sample segments 40 as possible in the thin ethanol layer at the bottom surface of dish 42. Also, debris (e.g. husk fragments, anther pieces, and insects) can be manually removed.

As shown at FIGS. 3B and C, a properly prepared Petri dish 42 would have segments or cuttings 40 fairly well distributed across that general plane. Settled and distributed cuttings 40 would present themselves, as illustrated in FIGS. 3B and 3C, such that their lengths are generally parallel to the plane of the bottom of dish 42.

Other containers or carriers for holding a sample, with or with liquid, during imaging are possible.

d) Imaging Station

Petri dish 42 (or a similar container) is placed generally orthogonal to and along the optical axis 55 of a camera 54 in imaging station 50 (FIG. 4). This could be accomplished by having a marking on a stage 52 or by having a receiver or jig into which dish 42 fits to make sure each dish 42 is imaged in the same location relative camera 54 or its field of view.

Imaging station 50 (e.g. Visage 110 imaging station from BioImage, Ann Arbor, Mich. USA) is essentially a dark room or enclosure 56. The interior walls (FIG. 4) can be painted or covered with a dark color to deter reflections. Camera 54 is suspended above stage 52 so that the entire Petri dish 42 would be within the camera's field of view. Camera 54 would be focused on substantially the plane of the bottom surface of the Petri dish 42 when in position on stage 52.

A light box or diffuse illumination source 60 (e.g. Benchtop White Light Transilluminator, Catalog No. 21475-460 from VWR) can be mounted or placed laterally (approx. 15 cm) from one side of stage 52. Light box 60 is configured to generate (a) enough light to obtain sufficient contrast in the image between cuttings 40 and background, but (b) quite diffuse light from its window 62 laterally across stage 52 to deter reflections or glare, and also optimize contrast. The lighting could be steady-state or strobed. Methods should be used to minimize glare and other lighting effects that disrupt the clarity and contrast of the image. Such methods are convention and well known in the imaging and photographic arts.

A dark cover or door (not shown) could be placed or moved across the front opening to enclosure 56 when the image is taken to eliminate or reduce ambient light.

As can be appreciated by those skilled in the art, the precise imaging station 50, and components thereof, can vary according to need and desire. In this specific exemplary embodiment, camera 54 is a digital camera, specifically a CCD imager. An example is an Evolution MP Color 5.1 Megapixel camera (from Media Cybernetics, Inc., 4340 East-West Hwy, Suite 400, Bethesda, Md. USA) with Series E 25 mm 1:2.5 (179611) Nikon Lens, an NA C-Mount Adapter and a Tiffen Cir. Polarizer (52 mm). Another example is a black and white (12-bit grayscale) Quantix 6303E CCD digital camera (from Photometrics of Tucson, Ariz. USA) with Nikon AF Nikkor manual focus lens set at a fixed focal distance. Other devices to obtain an image that can be analyzed with image analysis software are possible. An example is a digital scanner.

Three replicate images of each dish 42 can be obtained to improve accuracy (the three counts can be averaged or otherwise statistically utilized). The counts can be exported into a software application (e.g. Microsoft Excel) for further statistical analysis.

Other or additional methods of increasing contrast between the target sample and background (or non-relevant materials) can be used. For example, an option would be to select an illumination source with a wavelength that causes fluorescence (native or from a dye that adheres to the cuttings) of cuttings 40 to increase contrast. Another option would be to add a stain adapted to identify the presence of a gene in cuttings 40, if plant or animal material, by fluorescence upon illumination by certain light energy (differential staining). A still further option specifically for plant silk is use of a specific dye for pollen or pollen tubes so that the image could identify how many fertilizations have taken place at the time of image. Of course, other methods and components are possible.

It is further noted that transfer from vial 30 of FIG. 2 to dish 42 of FIG. 3A (or transfer between other containers or carriers) may not be necessary if the lighting contrast and the distribution of cuttings 40 are sufficient in vial 30 (or another original container or carrier) so that the image differentiates between a sufficient number of the cuttings 40 and background.

e) Computerized System

A computer (e.g. PC 72) includes image recognition or analysis software 80 (e.g. Image Pro Plus 6.2 software commercially available from Media Cybernetics, Inc.). The software can be specifically adapted for geometrical measurement of objects in a digital image. The software allows custom programming by the user by application-specific scripts. The software also allows a variety of ways to store and process the analysis information it generates. The software is compatible with many, if not most, recent model PC-type computers.

In this example, PC 72 can be interfaced (with an appropriate interface 74) to camera 54 of imaging station 50 (see FIG. 5) to operate camera 54 upon instruction from PC 72. PC 72 also could be interfaced (by appropriate interface 78) with a bar-code reader 76 (with associated software) to read the bar code information from vial 30 (or Petri dish) and correlate it to an image of the same sample. In this example, computer 72 also includes a spreadsheet program 82 (e.g. Microsoft Excel), to allow display and storage of data and the images.

Details about Image Pro image analysis software 80 can be seen at www.mediacy.com. In the case of cuttings 40 from maize silk obtained with tool 10 of FIGS. 1-3, software 80 would be programmed to identify objects in the image that are indicative of the size of the approximately 2 mm long silk segments. Software 80 can be programmed to remove irrelevant parts of the image before analysis.

For example, the field of view of camera 54 can be set to be large enough to capture every part of a plan view (e.g. FIGS. 3B and C) of dish 42 (so that no possible cuttings 40 are missed). However, this will likely bring areas outside of dish 42 into the image. A tool in software 80 is available to exclude from analysis anything outside the perimeter of the image of dish 42.

Software 80 is programmed to count silk cuttings 40 as follows: The implemented analysis procedure involves 1) automatically identifying the Petri-dish and setting an area of interest that excludes the rim and the area outside the dish, 2) application of a filter to improve contrast of the silks with the background, 3) identifying objects in the image and measuring their area in pixels, 4) classifying the objects into up to 16 “bins” or classes based on area relative to the estimated area of an individual silk (thus allowing for an estimation of the number of silks in clumps of touching or overlapping silks), 5) the number of objects in each “bin” is multiplied by the number of silks related to each of the “bins” providing the total silk count for each bin. The total silk counts for each bin are summed to arrive at total silk count for all bins, and thus for the entire sample in the Petri dish.

This procedure makes the analysis relative to the image itself and is thus self-calibrating so that changes in the size of the image or changes in the location of the Petri-dish are irrelevant.

FIG. 7 is an exemplary computer screen display graphic user interface for image analysis system 70. It illustrates the silk cuttings counting procedure. The upper left hand quadrant of the display is the captured image of cuttings 40 in a Petri dish 42. Note that many cuttings are separated from all other cuttings, but a substantial number are touching or overlapping. The lower right hand quadrant displays, for this embodiment, 16 bins or classes (left hand vertical column labeled “CLASS”). Each bin or class is defined by a range of total area. In this example, total area is number of pixels occupied by a contiguous object in the image of the upper left hand quadrant of FIG. 7. In the example of FIG. 7, 383 objects fitting within the range of pixel areas of class 1 are identified by software 80 (see vertical column labeled “OBJECTS”). The mean area of each of those objects is 356.78067 pixels (see vertical column labeled “MEAN AREA”). In contrast, 42 objects were identified within a range of areas designated as class 2 area. The mean area is 720.71429 pixels (roughly double the mean area of class 1). Twelve objects were identified in area class 3 (mean area 1084.6666 pixels, roughly three times the mean area of class 1). Four objects are identified in each of classes 4 and 5 (with mean areas roughly four and five times, respectively, the mean area of class 1). No objects were identified in classes 6 and 7 but one was identified in class 8; with an area roughly 8 times the area of class 1.

The upper right hand quadrant of FIG. 7 shows how a final silk count number is computed. Objects in class 1 are assumed to be single silk cuttings. Therefore, 383 silk cuttings are assumed and are placed in vertical column “F” of the table in the upper right hand quadrant of FIG. 7.

Identified objects with a mean area roughly double that of class 1 (in other words, class 2 objects are assumed to be two silk cuttings either touching or overlapping in some manner). Therefore, the 42 objects identified in class 2 are multiplied by two to give an estimated 84 total silk cuttings from class 2.

This relationship is continued for the remaining classes. Class 3 objects, roughly three times the mean area of class 1, are multiplied by three to arrive at an estimated 36 individual cuttings for class 3. Class 4 identified objects are multiplied by four and class 5 objects multiplied by five to arrive at 16 and 20 total estimated silk cuttings for classes 4 and 5, respectively. Finally, one object identified in class 8 is multiplied by eight (on the assumption that approximately eight individual cuttings make up the clump or cluster of cuttings identified in the class 8 image) such that eight individual cuttings are estimated for class 8. Each of the estimated individual cuttings in column “F” of the upper right hand quadrant of FIG. 7 are added together to arrive at “total number of silks” estimate, in this example 547. As described above, this methodology allows the programmer to predesign criteria used to recognize what are generally called objects in the image. These objects might consist of individual cuttings 40 or plural cuttings 40 (adjacent, abutting, overlapping, in clumps or in clusters). An initial determination or isolation of individual cuttings 40 does not have to be made. Moreover, the programmer can make use of filtering ranges to avoid counting non-silk objects in the image such as light reflection in the dish or pieces of leaf.

Classifying or binning objects into bins or classes based on total area of each object (in this example based on number of pixels substantially occupied by the object) then allows an estimation of how many cuttings 40 make up an object by comparing the average area of a single cutting 40 to the area of each recognized object. If the area is within the range of areas designated for the first class or bin 1, it is assumed to be a single cutting 40. The number of objects identified by area to fit within class 1 would then be the same number of cuttings counted for that class.

As indicated in FIG. 7, recognized objects that fall within a range of total areas for bin or class 2 would be assumed to be more than one cutting but less than three based on that calculated area. In other words, it is assumed objects in class 2 are two individual cuttings 40. The number of objects recognized in class 2 would be multiplied by two to arrive at the total number of individual silks counted for class 2.

This procedure continues in a like manner for classes 3 and up. The number of objects recognized for a class would be multiplied by the class number to arrive at total number of silks for each object in the class.

This is illustrated in highly simplified form in FIG. 6. Software 80 would identify the objects labeled “OBJECTS” “1”, “2”, “3”, “4”, and “5” in FIG. 6. This could be based on the contrast of OBJECTS 1-5 relative to background. It would also recognize the items labeled “leaf piece” and “unknown” in FIG. 6, but ignore them as they would not fit preprogrammed criteria (e.g. size, shape, dimensions or color) for what might be and individual cutting 40 or clump or cluster of cuttings 40. Software 80 would automatically count the objects meeting its test (within a programmable acceptable range) and ignore the others (e.g., “UNKNOWN” or “LEAF PIECE”). Thus, a count of what are identified by software 30 as silk sample pieces 40 is automatically obtained.

FIG. 6 includes five identified objects (1-5), but seven estimated individual silk cuttings (1-7). Objects 1, 2, and 4 are individual silk cuttings that have a total pixel area within a range of 6 to 10 pixels, with a range of pixels in at least one axis of at least three pixels. On the other hand, objects 3 and 5 have 16 and 18 pixel areas, respectively, much larger and approximately double that of objects 1-3. Because each of objects 3 and 5 meet a criteria for considering them to be composed of silk cuttings, objects 3 and 5 would be counted but classified in a higher class than objects 1-3 because of their larger total area. Based on programming, because they are roughly double the pixel area of objects 1, 3 and 5, they would be classified in class 2. When calculating total silk cuttings, objects 3 and 5 would each be considered to be composed of two individual silk cuttings and thus total silk cuttings for all objects 1-5 in FIG. 6 would total seven instead of five. Note that the count is intended to include even silk pieces that overlap one another. Even though the area of cuttings 3 and 5 would likely not be exactly double the area of objects 1, 2 and 4, they would be within an area of range considered to be indicative to two cuttings that either are touching, overlapping, or otherwise identified in the image as a single object. Note also that there can be some range of areas of individual cutting objects, as illustrated in FIG. 6. Thus, a range of pixel areas for class 1 objects is utilized, as is the case for all classes.

Depending on the application, it may be more practical and/or accurate to use more than simple width and/or length to separate non-silk from silk objects with image recognition. Criteria such as color, roundness, and roughness of the object circumference could be used to fine-tune the discrimination.

As can be appreciated, the images can be taken in color, black and white, in false color or captured with a sensor sensitive to specific wavelengths of light. Imaging may also be conducted sensing devices that do not rely on visual wavelengths for image creation (e.g. 3-dimensional laser, sonar or radar scanners).

Software 80 can be programmed to display on computer 72 the camera image and/or a report of the software 80's analysis of the image (see example of FIG. 7). As can be appreciated, software 80 can be programmed to have a number of functions. As indicated in FIG. 7, the Image Pro Plus software allows quite sophisticated functions. As described previously, one is to have the software 80 put different recognized measured sizes or shapes into different classes (up to sixteen in FIG. 7). The 16 classes represent objects of increasing large area, thereby likely representing clusters of an increasing number of silks. Non-silk objects are removed by a filter prior to counting of silk objects. Color coding allows the operator to verify that the bins do in fact represent the correct number of silks (e.g. the operator can easily distinguish clusters of two versus three silks by eye and can verify that the binning process reliably color codes those clusters appropriately). The classes could be color-coded on the PC 72 display (e.g., different colors could be associated with each line (or class) in the left column of the lower-right table in FIG. 7 with the colors of the cuttings in the picture of FIG. 7).

Optimally, the user could review the displayed image (and/or the actual sample in the Petri dish 42), and confirm whether or not certain objects in the image should be counted, to give an added level of accuracy and flexibility. The user can also make other changes or adjustments to the count or other data in post-processing. For example, the user could view the image and delete objects in the image that are clearly not relevant prior to object recognition or counting.

In FIG. 7 the lower right panel of the program identifies number of objects that are single (383), doubles (two silks overlapping) (42), triples (3 silks overlapping) (12), etc., and this is transferred to Excel (upper right panel), where the class number is multiplied by the number of objects placed in each class, and then summed to give a total silk count for the sample (see 383+84+36+16+20=547). As can be appreciated, the imaging software is highly flexible and programmable by the user to allow desired variations from that described above The software can be programmed and adjusted according to need or desire, and/or empirical testing, to achieve acceptable levels of accuracy of count.

As can be further appreciated, some preparation for imaging can be done manually by the user. For example, the user could visually inspect the Petri dish 42 and manually remove any debris or non-silk materials. Additionally or alternatively, foreign objects can be deleted from the image after image capture. The user can also shake, stir, or perturb the dish 42 to promote separation and distribution of the silk cuttings 40.

2. Operation

An exemplary protocol of operation of exemplary embodiment one is set forth below:

Table 4.1 Summary of Silk Counting Protocol

1. Scheduling and Labeling:
When the crop is knee high identify ten consecutive plants in a well-bordered section of a row of plants. Use a measuring stick to ensure the plants fall within a specified length of row. Tag first and last plant in the measurement area, so as to designate plants for later identification.
Record date of 50% silk for the whole plot and schedule plots for sampling 75-100 Growing Degree Units (“GDU”) later (3-5 days). GDU is a well-known parameter in plant science that describes time in terms of temperature accumulation.
Prepare vial labels for each sampled plant in advance.

2. Equipment required for field
Cutting tool 10 of FIGS. 1A-E.
Trays of labeled 10 ml scintillation vials 30 (FIG. 2) with screw caps, and bandolier set up to hold vials for five plots.
Apron, and IL bottle of ethanol plus hand pump.

3. Field procedure
Load bandolier with labeled vials 30 in sampling order before entering the plots.
Start with first labeled plant in the plot. Visually observe silk brush. If silk number is <50, count by hand, record silk number on vial label and take no physical silk sample. This can be faster and more accurate than trying to collect silk samples with very few silks.
If silk number is >50, attach vial 30 to Cutting tool 10, hold with vial 30 upwards, tease out the silk so there is a clean section of exposed silks 1-1.5 cm above the tip of the husks, place cutting tool 10 on exposed silks while holding the silk brush 38 in the other hand. While providing slight tension on the silks with one hand, squeeze the handle of the cutting tool 10 until all silk pieces have been cut. Do not completely close the cutting tool 10. (See FIGS. 1A-E).
Discard the distal, severed portion of silk brush 38. The vial opening should remain facing upwards throughout the procedure to prevent inadvertent loss of sample. Clear the silk pieces 40 from the cutting mechanism 10 by squeezing the handles 18/22 of the Cutting tool 10 completely closed. Squirt ethanol repeatedly through the hole 33 (FIG. 1B) above the vial 30, and wash the sample 40 through into vial 30 with ˜10 ml of 70% ethanol.
Unscrew vial 30, cap tightly (with cap 32), and shake to disperse the clump of cut silks 40.
Move to the next plant in the row and repeat.
When all sample vials 30 in the bandolier have been filled, transfer vials 30 to a scintillation vial storage tray (not shown) and reload bandolier with the next set of vials 30.
At day's end, clean the cutting tool 10, check that vials 30 contain at least ⅓ of their volume in ethanol, tighten vial lids 32, and store capped vials 30/32 in a cool, indoor area until counted.

4. Laboratory Equipment Needed
Fixed focal length CCD camera 54 mounted over a plywood template or stage 52 painted black or navy blue, and holding a 7 cm diameter glass Petri dish 42 with 14 mm sides; transilluminator side light source 60 covered with silk diffuser cloth. All are mounted in a fume hood 56.
PC 72 equipped with Excel 82, ImagePro® 80, custom designed software scripts; a bar-code scanner 76.
Fine-nosed tweezers and ethyl alcohol wash bottle.

5. Steps in Counting Silks
Empty silk sample 40 into Petri dish 42 and rinse vial 30 with ˜10 ml of ethanol.
Scan barcode on sample vial 30, and retain vial 30 for washing, label removal and reuse.
Remove any non-silk objects (e.g. husk tips, anthers, insects) from the sample 40 with tweezers, stir to break up clumps, and place Petri dish 42 on template 52 beneath camera 54. Let sample 40 settle for 5 seconds.
Initiate custom designed software script on PC 72 to image sample 40, store the image on the hard disk drive of PC 72, automatically bin overlapping silk pieces, and store bin information in Excel 82.
Check image on PC 72 screen for focus and adequacy. Repeat image capture step if necessary.
Remove Petri dish 42 and rinse carefully with ethanol.
Repeat above steps with a new sample.
At the end of the measurement period transfer sample code and silk number to master file using appropriate Excel 82 macros.

As can be seen, embodiment one allows silk cutting samples 40 to be obtained from growing plants and brought to a centralized counting station. Each sample 40 is correlated to the plant from which it came. This correlation can quickly be entered into the computer 72 at the counting station, e.g. by a quick reading of the machine-readable label 34 on the sample container 30. The operator can prepare and place a sample 40 in the imaging booth 50, take the image, and let the software 80 automatically identify and count the number of cuttings, and thus generate a silk count for the plant which would be automatically stored in a spread sheet or database associated with the plant from which it came (and/or associated information like inbred or hybrid variety type, experimental plot location, etc.).

The time savings of such a protocol for maize silks have been demonstrated (one estimate is of an approximate ten-fold improvement, e.g. from 50-60 ears or samples a day to 500 to 600). An unlimited number of samples can be obtained from growing plants and brought to the imaging location. The operator can, as quickly as possible, image samples successively. The counting processing can occur immediately or be deferred. For example, images of 10000 samples could first be obtained. Later, the image analysis of those 10000 images, to obtain silk counts for each image, could occur in a separate location in batch mode with no need for a human operator.

Accuracy of count has been demonstrated to be within an acceptable range. Operator checks and post-processing can increase the accuracy level. A preliminary goal of being able to detect a 10% difference in silk number from an average of 700 silks per ear has been demonstrated. Accuracy was indicated to be at least as good as manual hand counts.

Acceptable accuracy could be, for example, within 10 percent of actual count for an average of 700 silks per sample. Using embodiment one, results on the order of the following have been obtained. Total measurement system variability of 0.33% (4% or so considered acceptable) with 0.23% and 0.10% of the variability contributed by gage repeatability and operator reproducibility, respectively. This could be improved by using an average count of three repeated image analyses. FIG. 15 indicates (for n=324 samples) a good correlation between counts obtained with embodiment one and hand counts (linear regression analysis of R²=0.99). Relative standard deviation (RSD) for replicate silk counts averaged 2% and actual difference with hand counts averaged 3% within the range of 25-700 silks.

Speed over hand counting was shown to be on the order of 10 times faster with acceptable accuracy. As such, a relatively high level of sample throughput can be achieved.

As can be appreciated, additional automation is possible. Through robotics, conveyors, or other programmable actuators, emptying of the sample-holding container (whether vial, dish, or other) to prepare the sample for imaging could be accomplished. These types of components are commercially available and customizable for such purposes.

There are a number of commercially available, imaging stations and image analysis systems available. Some may even be ready to use with little or no modification. They allow efficient acquisition of digital images of many samples. The images can be displayed, archived, and evaluated, and can be created in many formats (e.g. bmp, zvi, jpg). The software identifies objects in the images that meet pre-programmed measurements or characteristics, and counts all such objects. The system makes quantitative measurement of objects in the images and stores the counts with information that relates the count to sample identification. The software allows interactive measurement tools and parameters (e.g. scaling, length, outline, angle, circle, event counting). The correlated count and sample identification can be placed in a database for further use (e.g. use the count of silks from the sample to estimate total yield of an ear or plant). After calibration, the system can automatically take sequential images of multiple samples (or replicates of samples), archive the images in searchable format, and repeat for a next set of samples. The system can evaluate, measure, count, and store the results. The system can be programmed to perform calculations on the counts to extrapolate information from them. The system includes functions like sample positioning, automatic focusing, image acquisition in several fluoresce channels, acquisition of image series from different focus positions, acquisition of image series over time, automatic measurement (programmable), image cataloging and archiving (searchable), recording and automatic execution steps. Measurement can be based on a wide range of parameters (e.g. geometric and/or densitometric).

Measurement data is easily exported to most spreadsheet programs, including Microsoft Excel. For example, ZVI format allows the image data to be stored in digital memory together with image number, acquisition date, microscope settings, exposure data, size and scale data, contrasting technique used, and other data. A generic template has been developed to take the output from the ImagePro™ software into Excel.

Simple configuration wizards allow the user to create a desired measurement program. Parameters describing the specimen can be determined by the user interactively. Those parameters can be instructed to be executed in a particular order. Automatic measurement of the high resolution images can be by length, area, perimeter, circle, angle or other geometric or densitometric parameters. The software automatically counts and/or marks events on images based on the programmed measurement parameters.

Commercially available image evaluation software can be used with imaging station 50 and computer 72 to produce a count of discernable objects in the image that match criteria consistent with a silk cutting. Such criteria can be programmed via the software. The software can be instructed to automatically produce the count. Some software allows the user to override or change the count. This could occur, for example, if the user displays the image on the computer 72 display and sees that the software has either preliminarily counted or failed to count an image object. The user can, by visual examination of the displayed image, determine whether a count should or should not be made, and change the software's count. Specific functions and aspects of such image evaluation software are well known in the art. Another example would be a software driver that could turn the camera on and off according to a programmed protocol.

Example one is one system and method to efficiently obtain quantitative counts of maize silk with relatively high throughput for samples. It can be appreciated that the system and method can be analogously applied to other plant or non-plant elongated strands or pieces.

### E. Specific Exemplary Embodiment Two—Fluid Flow

### 1. Summary

Another way to automatically count silk cuttings is illustrated at FIGS. 9-12. Instead of having to distribute the sample in a Petri dish, image it, and use image analysis software to measure and count objects in the image meeting a pre-defined test, this Exemplary Embodiment Two can obtain the samples in the same way as Embodiment One (e.g. by the cutting tool 10 previously described), but uses a different counting method.

Specifically, each sample 40 of cuttings from a plant 202 is quantified by a detector which is adapted to detect and digitally count individual silk cuttings that pass by the detector. The sample 40, the collection of up to hundreds of silk cuttings, is collected in a vial 30. The contents of vial 30 is poured or evacuated directly into a flow path, conduit, or tube 207, which directs the cuttings, in singulated fashion, past a detector such as a photo detector. The cuttings are singulated sufficiently to be counted. The passage of each cutting is recorded by photo detector, thus obtaining a count of total number of cuttings or silk segments. The system is cleaned and then the next sample 40 is sent through and counted. The detector can be communicated to a computer which can record the silk count for each sample and correlate each count to its respective sample or plant.

### 2. Apparatus

FIGS. 9 and 10 illustrate a basic set up for Embodiment Two. The goal is also to obtain a quantitative count of pieces in a sample of a plurality of strands, and to do so in a reasonably efficient, high throughput manner.

In this example, a principal difference from embodiment one is the manner in which a count is obtained. The individual pieces are generally singulated in a fluid flow past an optical detector that senses the presence of a piece versus the absence of a piece in the flow path.

As indicated in the example of counting silk cuttings in FIGS. 9 and 10, silk cuttings 40 (1 to 2 mm in length) from an ear of maize are suspended in an fluid solution of at least 200 ml or a volume that minimizes clogging and optimizes singulation in a given system. An example of the fluid solution is histological grade liquid ethanol because it preserves the sample and the sample's silk cuttings tend to singulate well in it. The ethanol can be automatically mixed with the cuttings (see FIGS. 9 and 10) from a bulk ethanol container 206. It is also believed possible to move the cuttings 40 past a detector 214 with other fluids, including gas (e.g. air), so long as the cuttings can be singulated sufficiently.

The cuttings, in fluid suspension, are pumped by a peristaltic or other suitable pump 208 into a conduit 210 that transitions to a relatively narrow tube 212 (<1 mm i.d., Tygon® 2075) at the detector 216 location for the purposes of promoting singulation of the cuttings as they move by a detection point in the tube 212.

In the example of FIG. 9, the sample and ethanol liquid mixture is split and processed in two parallel paths, e.g. into two identical two narrow tubes 212A and B, each with a sensor or detector 214A and B, for higher throughput. Each sensor 2146A and B would be in operative communication with a corresponding digital counter 216A and B to record the detections of each detector 214A and B and the counts would be added together for a count of the whole sample. Obviously, the sample/liquid mixture could be processed in just one path by one detector.

In this example, the detector or sensor 214 could be a band-type laser sensor (e.g. Model D12 DAB6FPQ5 available from Banner Engineering of Minneapolis, Minn. USA). This is essentially a type of photo detector that uses a laser having a defined band width (as opposed to a narrow single beam) to detect the passage of objects by measuring reflectance. This type of sensor is well-known and produces a digital output of the count.

The photoelectric sensor 214 has two main components: an emitter and a receiver. The emitter contains the light source, which can be, e.g., an LED or a laser. The emitter's light source is pulse-modulated by an oscillator. The receiver contains an optoelectronic element, such as a phototransistor or a photodiode which detects the light from the emitter, and converts the received light intensity to an electrical voltage. That voltage is amplified and demodulated. The receiver is “tuned” to the pulse frequency of its emitter, and ignores all of the other ambient light, which is gathered by its lens. The receiver is set to produce an output signal, which occurs either above or below a specified intensity of the light received from its emitter. Most sensors of this type allow adjustment of how much light will cause the output of the sensor to change state. Thus, each time a silk cutting (or other piece to be counted) passes the sensor beam from the emitter, it attenuates the intensity of the beam at the receiver to below a threshold, and generates an output signal. The output signal is sent to a commercially available digital counter 216, which increments upon every receipt of an output signal.

As can be appreciated, embodiment two can be implemented in a variety of different ways with a variety of different components. For example, an alternative sensor 214 is a Checker brand photoelectric sensor from Cognex Corp. of Natick, Mass. USA. Others are possible.

Examples of other sensors for counting silk cuttings 40 include, but are not limited to, a variety of single beam photoelectric sensors from, e.g., Balluff USA, 8125 Holton Drive, Florence, Ky. USA (see FIG. 12A), a fiber optic photoelectric sensor model FU-12 from Keyence Corp. of America, 50 Tice Blvd., Woodcliff Lake, N.J. USA.

As indicated in FIG. 9, there can be a filter after the sensor(s) 214 to recover the sample and also allow passage of the fluid to a flask or other container 224 for recovery, or recirculation and reuse.

FIG. 10 illustrates a prototype lab set up for such a system. As shown, the sample cuttings 40 and a measured quantity of fluid from bulk container 206 could be manually input into system 200. Pump 208 would pump the sample/fluid mixture in a liquid column through the narrow, simulating tube portion 212. Detector 214 would increment counter 216 upon each event indicative of a cutting passing by it. Battery 218 can power the detector. The sample/fluid mixture could be pumped into a flask or other recovery container 224. The cuttings 40 could be filtered out prior to this, if desired. By appropriate selection of components, a sample could be processed quite quickly.

Continuous agitation of the sample was found to increase accuracy by reducing clogging and promote silk separation. Bubbles or air in the conduits caused some variability. Methods to reduce this variability are within the skill of those skilled in the art.

As can be appreciated, this Embodiment Two may be constructed with components that allow it to be portable (e.g. small and light weight enough to be contained in a backpack). The system could be contained within a backpack and powered by battery power. This would allow the operator to take the system to the field and perform the silk counting at or near the plant(s).

FIGS. 12B and D illustrate how the sensor 214 can be supported adjacent to the transparent liquid conduit through with the sample/liquid mixture flows. For example, an articulatable holder with clamps could support a split line 210A and B and two detectors 214A and B (FIG. 12B). An alternative would be wire mesh screen as illustrated in FIG. 12D. These configurations are intended to provide stability to the components to increase operation and accuracy. Other arrangements are, of course, possible, including more permanent configurations. Fixture arrangements and stabilization of components can be key towards optimizing the system.

FIG. 11 illustrates another possible configuration. A vial or container 30A could be placed in the flow path from pump 208. Sample 40 could be inserted into vial 30A. Sample 40, suspended in liquid being pumped from pump 208, would be pumped past photodetector 214 for quantification of silk cuttings, and then recaptured in second vial 30B. In this manner, the sample/liquid mixture can be measured but then placed back into a sample holder for preservation.

### 3. Operation

Operation of such a system 200 can be as follows. The sample cuttings can be collected in a Scintillation vial, ethanol added, and then the ethanol/cuttings content poured into an inlet (e.g. funnel 207—see FIG. 10) to the pump system. Care should be taken to get all the cuttings out of the vial and into the pump 208. Pump speeds and fixture arrangements can be optimized by empirical testing. Adequate separation of silk cuttings depends on sample size, volume of liquid, effectiveness of agitation, liquid flow rates and sensor detection capabilities. These also can be optimized by empirical testing. Use of air or vacuum are possible alternatives to pumping the cuttings in liquid to minimize pulsating action of a pump.

Processing speed on the order of one sample every few minutes (or less) may by possible. This depends on the number of channels and optimization. As can be appreciated by those skilled in the art, normal empirical testing can be conducted to calibrate operation of the components.

Accuracy was shown to be acceptable for many applications. FIG. 16 shows a comparison between maize silk count for embodiment 2, with Banner band type laser sensor (model D12DAB6FPQ5) relative to count of the same samples by embodiment one. Table 1 of FIG. 16 does indicate an average error of 52%, but was likely due to calibration issues and sensor stability. Table 2 of FIG. 16 shows a reduction of average error to around 8% by stabilizing the sensor with a screen grid (FIG. 12D) or other holder or stand (FIG. 12B—showing use of a stand—e.g. “Helping Magnifier” stand from Harbor Freight Tools, Camarillo, Calif. USA used, e.g., for soldering applications).

The general method of using photosensors to count individual sample cuttings by suspension in fluid and pumping or movement past the photodetector can be adjusted and optimized by the user. It can be implemented in an analogous way to other plant and non-plant elongated strands or pieces. Capture and storage of the count can be easily accomplished by communicating a digitized count from a digital counter 216, which would be in a format that could be understood and used in a computer. The user could maintain identity of each sample and its count in a spreadsheet or database in a computer. Like described in Example One, the count information for multiple samples could be used as needed and stored or archived.

### F. Specific Exemplary Embodiment Three—Silk Brush Cross Section Count

### 1. Summary

Another method of counting silks is illustrated in FIGS. 13 and 14A-C. The silk brush 338 of an ear of corn is held or pulled taut and held in place with, e.g., ¾ transparent adhesive tape 340 (FIG. 14A). The bound silk brush 338 is cut cleanly and transversely at or near both ends of the tape (FIG. 14B). This produces an inch long or so stable section of bound silk brush sample with opposite ends exposed to provide cross-sectional cuts of the entire silk brush 338. The sample is left at ambient temperature for a few minutes and each exposed silk end in the silk brush tends to blacken (FIG. 14B) This improves contrast. The exposed end of each silk can be manually counted, or an image can be obtained and manual counting done from the image. Alternatively, image analysis software, appropriately programmed, could perform an automated count.

### 2. Apparatus

A single bevel razor blade 344 or other sharp cutting instrument can make the transverse cuts (see cut lines 1 and 2) through the two locations of silk brush 338 to produce the exposed silk ends (FIG. 13). Each silk could be manually counted.

Alternatively, an image of the cross-section could be obtained and visual, manual or automated image analysis counting done of the image. Examples of imagers are Olympus model SZX12 stereoscope from Olympus Imaging America, Inc., 3500 Corporate Parkway, P.O. Box 610, Center Valley, Pa. USA, fitted with a Spot Insight Color camera, model 3.2.0 (at 7×−10×) from Diagnostic Instruments, 6540 Burroughs Street, Sterling Heights, Mich. USA. An alternative is a WILD-Heerbrugg model M3Z stereoscope (now Leica Microsystems (Switzerland) Ltd, Max-Schmidheiny-Str. 201, 9435 Heerbrugg, Switzerland) fitted with a Zeiss AxioCam MRc from Carl Zeiss MicroImaging GmbH, Gottingen, GERMANY. Others are possible.

Some type of staining or dye could be applied to the cross section to try to increase contrast between silks (compare top and bottom images in FIG. 14C). Visible or non-visible light could be imaged.

### 3. Operation

The method of FIGS. 13 and 14 would lend itself to portable field silk counting. Experience has been that this is slower than Embodiments One and Two (e.g. on the order of 50 samples handled per day).

### G. Options and Alternatives

It will be appreciated by those skilled in the art that variations to those described herein are possible with respect to the embodiments through which aspects of the invention may be practiced. The invention is not limited to the specific embodiments described herein. Variations obvious to those skilled in the art will be included within the invention.

A few examples are set forth below.

1. Apparatus

The precise system and system set-up can vary. The precise equipment and combination of equipment can vary according to desire or need. For example, the precise camera or software for Embodiment One can vary, as can its features and set up. The precise pump and detector of Embodiment Two can likewise vary. The designer can select and configure the equipment according to need and desire.

As can be appreciated, each of the examples could be made to be easily transportable and useable in a variety of locations, settings, and environments. They can even be made portable to provide counting at the location of the items to be counted. It can be portable because it can be relatively small in scale (both when assembled as an operating system, and as individual components), is relatively light weight, and can be battery powered (or powered from normally available electrical power sources). For example, with embodiment one, an imaging station 50 could be set up in or near a crop field. The enclosure could be like a portable fume hood and protect the imager from the environment. The images could be taken and stored on the camera and then analyzed with a laptop PC on-site, or a desktop computer in a nearby building. Alternatively, the images could be sent by email or other communication protocol or network to a central location for processing with image analysis software. Alternatively, the container including the silks could be used directly for imaging without the need to transfer to a second receptacle. With embodiment two, as indicated above, the pump, detector, and digital counter could be battery powered. The set up could be made on-site, including in a field or outdoors. And embodiment three, at least when using manual counting, is easily portable and can be practiced almost anywhere. There may be some trade-offs between a lab-based and a portable on-site system (e.g. resolution of images may be higher in lab setting; on-site processing may produce quicker and acceptable results). The user would factor these issues into the design of the system and method used for a given application.

2. Methods

Similarly, the precise method steps and sequence can have some variation. Also, the measurement related to a silk cutting can vary. For example, instead of count of silk cuttings, a measure of silk diameter or a measure of distribution of silk diameters could be made. This can be taken from images that already are archived from silk counting by appropriate programming of the image analysis software described regarding embodiment one, or could be the sole measurement made. Similar variations when counting other plant or non-plant pieces are, of course, possible.

3. Applications

Additionally, the application of the counting methods can vary. For example, the exemplary embodiments herein relate primarily to silk counting for live corn. It could also be applied, of course, to ears that have been separated from the plant. The counting apparatus and methods can, if desired, by applied to counting other small items in analogous ways. Others may be count of celery cellular structures. It may be possible to count such things as individual fibre optics in a fibre optic bundle. Others have been mentioned in this description. However, the invention is not limited to just those examples.

But furthermore, it is to be understood that the inventors have discovered that the present silk counting apparatus and methods can be extended to a variety of beneficial applications for plant research and development. The silk count not only can be used as an indicator of potential yield for the plant, but a number of other extensions from this have been discovered to be possible.

Silk count can be used in ways which may be able to materially assist in plant research and development. Some of these applications which use silk counting include, but are not limited to, the following:
a. Variation between plants regarding silk number or silk width (at one time or a comparison of several times),
b. Variation of silks within an ear.
c. Yield prediction (e.g. earlier yield estimation; input for production field yield estimate modeling).
d. Precision phenotyping of genotype (e.g. measurement of the speed and pattern of silk exertion for either hybrid and inbreds).
e. Discovery of genomic regions associated with variations in silking trait(s).
f. Decrease cost of goods sold by increasing yield per plant.
g. Use silk cutting to evaluate different transgenic constructs or events.

As can be appreciated by those skilled in the art, these applications can be applied beneficially in a number of ways. A few examples are as follows:

(a) Make selection at flowering time to be more efficient at harvest (i.e. plan harvest machines, labor, transportation, etc.).

(b) Seed yield management (e.g. determine factors limiting yields-amount of silk or amount of pollen).

(c) Promote tools for high throughput quantification of silk number to better understand female yield potential, stability, risk, and failures.

(d) Amend breeding strategies through better understanding of the factors determining yield potential.

(e) Implement silk counting into research procedures, breeding strategies, and production field management (management, risk assessment, budget yield estimation).

Further examples of applications are set forth in the following examples related to how counting methods such as described earlier might be applied in the context of maize silks.

### H. Further Exemplary Applications

The ability to take advantage of relatively high throughput counting of silks or other elongated pieces or strands is demonstrated by the following examples. These examples are related to maize silk, but are intended to illustrate how silk count(s) can sometimes correlate to other measures or parameters.

1. Measures of Silk Count

It is well-known in the art that a strong relationship exists between silk and ovule number, and this parameter is also an indication of kernel number/ear and potential yield. The present silk counting methodologies are adapted to assist in obtaining silk counts to a degree of acceptable statistical accuracy on a higher throughput rate than hand counting. The counts can be non-destructive to the plant. The methods allow counts to be taken efficiently.

A goal was to achieve accuracy of the counts to within +/−2% of hand counts. Counts across a wide range of silk numbers (80-900) were quite consistently within the +/−2% range considered acceptable (see FIG. 15) using the previously described imaging analysis technique of Exemplary Embodiment One. Results also can be within acceptable range for the liquid flow photo detector counter technique of previously described Exemplary Embodiment Two (see FIG. 16). The counting methods can be useful even for accuracy results lower than the above-described goal.

The development of a statistically acceptable method or methods of quantification of silk number in maize has been applied in a number of ways. Some non-limiting examples include methods that provide a more efficient way of investigating variability of silk number between different plants, between ears on the same plant, or even at different times on the same ear. This has opened up the potential for use of silk count in a number of ways to try to better understand silk and silk development, as well as ear and plant development, which can in turn lead to an improved understanding of plant traits and development.

a) Silk Variation within Ear or Between Plants

The silk counting methods of the exemplary embodiments have been used to establish variability between silk number of plants of different genotypes, plants of the same genotype, plants of the same and different genotypes grown in different growing locations under different environmental conditions, and plants of the same or different genotype grown with different covering treatments (e.g. silks covered or uncovered for a certain time) (see FIG. 17). This variability can be used in a number of ways.

For example, one would be to distinguish or identify different genotypes by silk number. Another would be to characterize a genotype or different genotypes based on silk production for different environments. Another would be to quantify degree of variability of silk count between plants of the same inbred or hybrid variety. Note how FIG. 17 also illustrates how silk number can vary from day to day over the silking period. As will be discussed later, this can also be used in characterizing or predicting a genotype or genotypes. The characterizations can be used to assess such things as production output affected by environment, genotype, or agronomic practices.

The methods also allow silk counts to be taken from the same ear at different times to study the dynamics of silk exsertion and growth.

2. Application of Silk Count

a) Number

Silk number has been applied in a number of ways to help understand the processes of a maize plant. As mentioned, one primary example is the relationship between silk number and genotyped as an identification tool.

As also discussed above, silk number has been correlated to potential yield from the ear or plant. Any yield reduction from potential, as measured by silk number, could represent lost business income potential to a seed producer. Silk counting is a valuable tool for assessing production output as affected by environment, genotype, or agronomic management practices. Using the silk counting methodologies of Exemplary Embodiments 1-3 described earlier, silk counting can be utilized in a relatively efficient way for these purposes. Such things as female yield potential, stability, risk, and failures can be studied more effectively.

For example, instability of yield is almost always associated with varying levels of stress interacting with an array of stress susceptibilities in target genotypes. Selection for improved yield stability in a breeding program or as part of a transgenic evaluation initiative can be a desirable goal for both seed company and grower. When the maize plant is under stress in the middle of the growing season, variation in grain yield is essentially variation in kernel number, through its variables, ears per plant and kernels per ear (KPE). Stress at flowering causes a delay in silk exsertion, often related to the time of anthesis as ASI (anthesis silking interval), since time to 50% anthesis is little affected by stress. The relationship of ASI to grain yield and KPE is well established, but the trait is temporal and reveals little detail about the overall dynamics of silking and pollen shed. These populations must overlap to ensure pollination, and silks and pollen must remain competent under stress to ensure fertilization and good kernel set. The dynamics of silk production in particular relate to inter-plant and intra-ear variation in silk growth, the uniformity of silk exposure, and its synchrony with available pollen. Selection for stable kernel set under stress requires the screening of large numbers of genotypes for traits that are critical to kernel set under a range of stress levels.

Below is a non-limiting discussion of various other examples of applications related to silk count.

Improving yield stability under variable levels of stress (drought, heat, density, and low nitrogen) should improve maize hybrid performance over time and environments and help increase and stabilize farm income. Reproductive processes occurring during the flowering period of maize are particularly susceptible to stress, and thus represent promising targets for improved yield stability. Results from initial studies in managed stress research environments confirm the strong dependence of grain yield on ear and ovary growth, silk emergence, and kernel growth following pollination when drought stress occurs during flowering. It has also been confirmed in these studies that genetic variation for stress susceptibility of these processes exists. The following are additional precision phenotyping tools for dissecting tolerance to stress at flowering and generating a phenotype that would serve as a model for improving yield stability in maize. Expected benefits include a high throughput precision phenotyping methodology for silk growth rate and within-ear synchrony of silking, as well as a procedure for determining the extent of kernel abortion during early ear growth. Selection for improved stability using these tools is expected to provide improved tolerance to an array of stresses that impact kernel number and hence yield.

b) Predictions

(1) KPE and Grain Yield

As mentioned, number of silks per ear is normally roughly indicative of ultimate yield for the ear as each silk should be associated with an ovule, which ideally should produce a kernel, which is a primary factor (along with kernel size) in determining grain yield. Using the methodologies of high throughput silk counting, quantification of silk number can be used in any number of ways to predict yield. It can be used to predict yield for an ear, for a plant, or for a genotype.

Through conventional techniques, the yield prediction can be used to assist a grower or seed production company in planning. Because silk count can be obtained relatively early in plant life, this information can be used well before harvest (essentially in the middle of the growing season).

What is claimed is:

1. A method for high throughput counting of individual silks of a silk brush of one or more maize plant comprising:
a. cutting a section out of the silk brush containing relatively short lengths of individual silks;
b. distributing the short lengths across or above a surface of a container;
c. imaging the container;
d. using image recognition software to evaluate the image for and count objects indicative of a cut short length of silk; and
e. storing the count correlated to the sample.

2. The method of claim 1 wherein the relatively short lengths of individual silks range from 1.5 to 2 mm in length.

3. The method of claim 1 further comprising:
a. processing the image to determine an estimate of at least one physical property of the sample of silks from the image;
b. comparing the estimate of the at least one physical property of the silks to estimates of the physical property of other plants to provide a comparison; and
c. evaluating the plant relative to the other plants based on the comparison.

4. The method of claim 3 wherein the physical property is one of size, number, shape, dimensions, average size, average shape, or average dimensions, distribution of sizes, distribution of shapes, or distribution of dimensions.

5. The method of claim 3 wherein the step of evaluating includes comparing the physical property to a physical property of other plants:
a. of a same variety to record any variation between them; or
b. of a different variety to record any variation between them.

6. A method of relatively high throughput counting of individual silks of a silk brush of a maize plant comprising:
a. cutting a section out of the silk brush containing relatively short lengths of individual silks;
b. moving the short lengths sequentially and substantially singulated past a detector;
c. programming the detector to count objects indicative of a short length of silk; and
d. storing the silk count correlated to the sample.

7. The method of claim 6 wherein the short lengths of individual silks are fluidized in air or liquid.

8. The method of claim 6 wherein the detector comprises a photodetector, laser, or particle counter.

9. The method of claim 6 further comprising using the silk count to:
a. predict variety, phenotype or genotype of a plant;
b. predict growing conditions of the plant;
c. select growing conditions for seed from the plant;
d. select further use of the plant for research;
e. select further use of the plant for commercial production;
f. evaluate different transgenic constructs or events.

10. A method of obtaining a sample of individual silks of a silk brush of a maize plant comprising:
a. holding the silk brush taut; and
b. cutting a cross-section of the silk brush by:
i. moving two spaced apart blades generally transversely through the silk brush to separate relatively short lengths of individual silks of the silk brush from the plant.

11. The method of claim 10 further comprising a blunt edge placed on the opposite side of the silk brush to the direction of cutting by the blades.

12. A method of counting individual silks of a silk brush of a maize plant comprising:
a. holding the silk brush taut;
b. cutting a cross-section of the silk brush;
c. counting exposed ends of the silks in the cross-section.

13. The method of claim 12 further comprising capturing a digital image of the cross-section of the silk brush.

14. The method of claim 12 further comprising staining the cross-section of the silk brush to enhance contrast between individual silks.

15. A method of selecting germplasm from between a plurality of different corn plants comprising:
a. counting number of silks emerging from each ear of a plurality of different varieties of corn plant; and
b. selecting a plant for further use based on the silk count.

16. The method of claim 15 wherein the selecting is a part of a program to:
a. improve breeding germplasm; and
b. improve a plant breeding program.

17. The method of claim 15 wherein the counting step comprises automatically or semi-automatically counting silks for an ear of corn and using the silk count for a further purpose, wherein the further purpose comprises one or more of:
a. quantification of variation between plants regarding silk number, length, width, or brightness;
b. quantification of variation of silks within an ear; and
c. yield analysis.

18. The method of claim 17 further comprising using the silk count for one or more of silk counting in research procedures, breeding strategies, or production field management.

19. A method of selecting a genotype of plant based on quantification of silk comprising:
a. obtaining a quantified count of a sample of silk from the genotype;
b. comparing an estimation of total quantity of silk from the genotype with reference information; and
c. deciding if the genotype should be selected for further use.

20. The method of claim 19 wherein the quantified count of the sample comprises;
a. obtaining a sample of each silk of like size;
b. distributing the samples generally uniformly in a plane;
c. imaging the samples;
d. evaluating the image with image analysis software programmed to recognize objects in the image indicative of a single sample of a silk;
e. storing a count of recognized objects; and
f. estimating total silk count from count of recognized objects.

21. The method of claim 20 wherein the count is used to predict grain yield of the plant.
